(19) United States
(12) Patent Application Publication
(10) Pub. No.: US 2023/0051588 A1
(43) Pub. Date: Feb. 16, 2023

(54) PRESSURE SENSITIVE ADHESIVE COMPOSITION

(71) Applicant: DOW SILICONES CORPORATION, Midland, MI (US)

(72) Inventors: Timothy MITCHELL, Midland, MI (US); Peng-Fei FU, Midland, MI (US); Zhenbin NIU, Midland, MI (US); Yanhu WEI, Midland, MI (US)

(21) Appl. No.: 17/789,183

(22) PCT Filed: Dec. 22, 2020
(86) PCT No.: PCT/US2020/066619

§ 371 Date: Jun. 25, 2022

Related U.S. Application Data
(60) Provisional application No. 62/955,126, filed on Dec. 30, 2019.

(51) Int. Cl. C09J 183/04; C09J 7/38

(52) U.S. Cl. CPC C09J 183/04; C09J 7/38

(57) ABSTRACT

A pressure sensitive adhesive (PSA) composition comprises (A) a silicate resin that is a liquid at 25° C. in the absence of any solvent. The (A) silicate resin includes an average of at least one silicon-bonded ethylenically un saturated group per molecule. The PSA composition further comprises (B) an organosilicon compound having at least two silicon-bonded hydrogen atoms per molecule. In addition, the PSA composition comprises (C) a hydrosilylation-reaction catalyst. The (A) silicate resin is miscible in the PSA composition in the absence of any solvent. The PSA composition can be at least partially cured to give a PSA.

### CROSS-REFERENCE TO RELATED APPLICATIONS

This application claims priority to and all advantages of U.S. Provisional Patent Application No. 62/955,126 filed on 30 Dec. 2019, the content of which is incorporated herein by reference.

### TECHNICAL FIELD

The subject disclosure generally relates to an adhesive and, more specifically, to a pressure sensitive adhesive composition including a silicate resin and related methods.

### BACKGROUND

Silicone compositions are known in the art and utilized in myriad industries and end use applications. One such end use application is adhesives. For example, silicone compositions may be utilized as pressure sensitive adhesives.

Conventional silicone-based pressure sensitive adhesives are often addition-curable. In addition, conventional pressure sensitive adhesives typically include tackifiers, which, for silicone-based pressure sensitive adhesives, are often solid MQ resins. To formulate such silicone-based pressure sensitive adhesives, solids, e.g. the solid MQ resins, are dissolved in solvent and combined with other components of the silicone-based pressure sensitive adhesive, and the solvent is later removed. Thus, even if silicone-based pressure sensitive adhesives are solventless, such solventless silicon-based pressure sensitive adhesives are still typically formed with solvent.

### BRIEF SUMMARY

A pressure sensitive adhesive least (PSA) composition is disclosed. The PSA composition comprises (A) a silicate resin that is a liquid at 25° C. in the absence of any solvent. The (A) silicate resin includes an average of at least one silicon-bonded ethylenically unsaturated group per molecule. The PSA composition further comprises (B) an organosilicon compound having at least two silicon-bonded hydrogen atoms per molecule. In addition, the PSA composition comprises (C) a hydrosilylation-reaction catalyst. The (A) silicate resin is miscible in the PSA composition in the absence of any solvent. The PSA composition can be at least partially cured to give a PSA.

A method of preparing the PSA composition and a method of preparing a coated substrate comprising a coating disposed on a substrate, as well as the coated substrate formed in accordance with the method, are disclosed.

### DETAILED DESCRIPTION

A pressure sensitive adhesive (PSA) composition is disclosed. The PSA composition comprises (A) a silicate resin that is a liquid at 25° C. in the absence of any solvent. The (A) silicate resin may alternatively be referred to as a silicone resin, but is a silicate resin in view of the presence of Q siloxy, or SiO_{4/2}, units in the (A) silicate resin. Generally, silicone resins and in particular silicate resins are solids at 25° C. due to their three-dimensional networked structure. In view of the difficulty of processing solid silicone resins, silicone resins are typically dissolved in solvent and utilized as a silicone resin composition, which comprises or consists of a solid silicone resin dissolved in a solvent, e.g. an aliphatic or aromatic hydrocarbon solvent. In this way, the silicone resin compositions are liquid at 25° C. or room temperature, which allows easier processing of the silicone resin compositions. For example, silicone resin compositions can be combined with other components or compositions for various end use applications in liquid form. Similarly, conventional silicone resins, which are solid at 25° C. in the absence of any solvent, are not readily miscible with liquid silicones. This means that when preparing silicone compositions, conventional silicone resins, which are solid at 25° C., cannot be readily mixed or solubilized with liquid silicones, e.g. liquid organopolysiloxanes, in the absent of organic solvent. Thus, when conventional silicone resins are utilized in silicone compositions, organic solvents are typically required for purposes of forming the silicone compositions and subsequently volatilized, either in composition form or when curing.

However, one drawback of silicone compositions is that the solvent is typically removed in end use applications. For example, when silicone compositions are utilized to form films, coatings or articles, the solvent is typically removed when forming such films or articles. This requires additional processing steps, as well as energy and related cost, for removal of solvent, e.g. via volatilization.

In contrast, the (A) silicate resin is a liquid at 25° C. in the absence of any solvent. Thus, the (A) silicate resin being a liquid at 25° C. is not attributable to the presence of any solvent, e.g. organic solvent, unlike conventional silicone resins. The (A) silicate resin consists of silicate resin without any solvent or carrier vehicle. Further still, not only is the (A) silicate resin a liquid at 25° C. in the absence of any solvent, but the (A) silicate resin is miscible with the PSA composition, including any organopolysiloxanes typically utilized therein. This allows for the PSA composition be readily formed without requiring any solvent, or related processing steps for removal of solvent from the PSA composition.

By “liquid”, it is meant that the (A) silicate resin is flowable at 25° C. and/or has a viscosity that is measurable at 25° C., in the absence of any solvent. Typically, the viscosity of the (A) silicate resin is measurable at 25° C. via a Brookfield LV DV-E viscometer with a spindle selected as appropriate to the viscosity of the (A) silicate resin. The viscosity of the (A) silicate resin may vary, particularly based on the content of M, D, T, and/or Q siloxy units present therein, as described below. However, for purposes of this disclosure, the (A) silicate resin can be in the form of a gum, as gums still have flowable characteristics, even if gums do not have viscosities that can be readily measured at 25° C.

In specific embodiments, the (A) silicate resin has the average formula:

[W]ₐ[X]_{b}[Y]_{c}[Z]_{d},

where 0<a<1; 0<b<1; 0≤c<1; and 0<d<1; with the proviso that a+b+c+d=1. Subscripts a, b, c and d are mole fractions of the W, X, Y, and Z units in the (A) silicate resin.

In the average formula above for the (A) silicate resin, [W], [X], [Y], and [Z] are utilized in lieu of the more common nomenclature [M], [D], [T] and [Q]. As understood in the art, M siloxy units include one siloxane bond (i.e., —O—Si—); D siloxy units include two siloxane bonds, T siloxy units include three siloxane bonds, and Q siloxy units include four siloxane bonds.

However, for purposes of this disclosure, [W] indicates siloxy units including one —Si—O— bond, which may be a siloxane bond or a precursor thereof. Precursors of siloxane bonds are −Si−OZ bonds, where Z is independently H, an alkyl group, or a cation, such as K⁺ or Na⁺, alternatively H or an alkyl group. Silanol groups and alkoxy groups can hydrolyze and/or condense to give siloxane bonds and are typically inherently present in most silicone resins. Such precursors of siloxane bonds can be minimized by bodying of silicone resins, which results in further condensation with water and/or an alcohol as a by-product. Thus, for purposes of this disclosure, [W] indicates [R₃SiO_{1/2}], where each R is an independently selected hydrocarbyl group.

Further, for purposes of this disclosure, [X] indicates siloxy units including two —Si—O— bonds, which may independently be siloxane bonds or a precursor thereof. Thus, for purposes of this disclosure, [X] is [R₂SiO_{1/2}(OZ)]_{b′}[R₂SiO_{2/2}]_{b″}, where each R is independently selected and defined above; 0≤b′≤b; 0≤b″≤b; with the proviso that b′+b″=b; and wherein each Z is independently H, an alkyl group, or a cation. Subscripts b′ and b″ indicate the relative mole fraction of [X] siloxy units indicated by subscript b′ and those indicated by subscript b″, respectively, with regard to the overall average formula of the (A) silicate resin, with the sum of b′ and b″ being equal to b. In [X] siloxy units indicated by b′, there is one siloxane bond and one Si—OZ bond, and in the [X] siloxy units indicated by subscript b″, there are two siloxane bonds.

Further, for purposes of this disclosure, [Y] indicates siloxy units including three —Si—O— bonds, which may independently be siloxane bonds or a precursor thereof. Thus, for purposes of this disclosure, [Y] is [RSi(OZ)_{c}′O_{3-c′/2}], where each R is independently selected and defined above; c′ is an integer from 0 to 2 and is independently selected in each Y siloxy unit indicated by subscript c in the (A) silicate resin. Thus, [Y] can indicate any combination of the following siloxy units: [RSiO_{3/2}], [RSi(OZ)₁O_{2/2}], and/or [RSi(OZ)₂O_{1/2}].

Further, for purposes of this disclosure, [Z] indicates siloxy units including four —Si—O— bonds, which may independently be siloxane bonds or a precursor thereof. Thus, for purposes of this disclosure, [Z] is [Si(OZ)_{d}′O_{4-d′/2}], where each Z is independently selected and defined above, and subscript d′ is an integer from 0 to 3 and is independently selected in each siloxy unit indicated by subscript d in the (A) silicate resin. The (A) silicate resin can include siloxy units indicated by subscript d where d′ is 0, d′ is 1, d′ is 2, and d′ is 3. The siloxy units represented by [Z] can have one, two, three, or four siloxane bonds, with the balance being Si—OZ moieties. Thus, [Z] can indicate any combination of the following siloxy units: [SiO_{4/2}], [Si(OZ)O_{3/2}], [Si(OZ)₂O_{2/2}], and/or [Si(OZ)₃O_{1/2}].

In certain embodiments, subscript a is from greater than zero to 0.9, alternatively from greater than 0 to 0.8, alternatively from greater than 0 to 0.7, alternatively from greater than 0 to 0.6, alternatively from greater than 0 to 0.5. In specific embodiments, subscript a is from 0.10 to 0.50, alternatively from 0.15 to 0.40, alternatively from 0.2 to 0.4, alternatively from 0.25 to 0.35.

In these or other embodiments, subscript b is from greater than zero to 0.9, alternatively from greater than 0 to 0.8, alternatively from greater than 0 to 0.7, alternatively from greater than 0 to 0.6, alternatively from greater than 0 to 0.5, alternatively from greater than 0 to 0.4. In specific embodiments, subscript b is from 0.10 to 0.30, alternatively from 0.15 to 0.30, alternatively from 0.15 to 0.25. Subscripts b′ and b″ define the relative amounts of particular siloxy units represented by [X]. As noted above, 0≤b′≤b; 0≤b″≤b; with the proviso that b′+b″=b. Subscript b′ can be 0 while subscript b″ is b, or subscript b′ can be b while subscript b″ is 0. When both siloxy units indicated by b′ and b″ are present in the (A) silicate resin, 0<b′<1; 0<b″<1; with the proviso that b′+b″=b.

In these or other embodiments, subscript c is 0. However, in alternative embodiments, subscript c is greater than 0, for example from greater than zero to 0.9, alternatively from greater than 0 to 0.8, alternatively from greater than 0 to 0.7, alternatively from greater than 0 to 0.6, alternatively from greater than 0 to 0.5, alternatively from greater than 0 to 0.4, alternatively from greater than 0 to 0.3, alternatively from greater than 0 to 0.2, alternatively from greater than 0 to 0.10, alternatively from greater than 0 to 0.08.

In these or other embodiments, subscript d is from greater than zero to 0.9, alternatively from greater than 0 to 0.8, alternatively from greater than 0 to 0.7, alternatively from greater than 0 to 0.6. Alternatively, in these or other embodiments, d is from 0.1 to 0.9, alternatively from 0.2 to 0.9, alternatively from 0.3 to 0.9, alternatively from 0.4 to 0.9. In specific embodiments, subscript d is from 0.35 to 0.60, alternatively from 0.40 to 0.60, alternatively from 0.40 to 0.55, alternatively from 0.45 to 0.55.

R is an independently selected hydrocarbyl group, and an average of at least one, alternatively at least two, of R are independently ethylenically unsaturated groups in each molecule of the (A) silicate resin. In general, hydrocarbyl groups suitable for R may independently be linear, branched, cyclic, or combinations thereof. Cyclic hydrocarbyl groups encompass aryl groups as well as saturated or non-conjugated cyclic groups. Cyclic hydrocarbyl groups may independently be monocyclic or polycyclic. Linear and branched hydrocarbyl groups may independently be saturated or unsaturated. One example of a combination of a linear and cyclic hydrocarbyl group is an aralkyl group. General examples of hydrocarbyl groups include alkyl groups, aryl groups, alkenyl groups, halocarbon groups, and the like, as well as derivatives, modifications, and combinations thereof. Examples of suitable alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, hexadecyl, octadecyl, as well as branched saturated hydrocarbon groups having from 6 to 18 carbon atoms. Examples of suitable non-conjugated cyclic groups include cyclobutyl, cyclohexyl, and cycyloheptyl groups. Examples of suitable aryl groups include phenyl, tolyl, xylyl, naphthyl, benzyl, and dimethyl phenyl. Examples of suitable alkenyl groups include vinyl, allyl, propenyl, isopropenyl, butenyl, isobutenyl, pentenyl, heptenyl, hexenyl, hexadecenyl, octadecenyl and cyclohexenyl groups. Examples of suitable monovalent halogenated hydrocarbon groups (i.e., halocarbon groups) include halogenated alkyl groups, aryl groups, and combinations thereof. Examples of halogenated alkyl groups include the alkyl groups described above where one or more hydrogen atoms is replaced with a halogen atom such as F or Cl. Specific examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl groups, as well as derivatives thereof. Examples of halogenated aryl groups include the aryl groups described above where one or more hydrogen atoms is replaced with a halogen atom, such as F or Cl. Specific examples of halogenated aryl groups include chlorobenzyl and fluorobenzyl groups.

In specific embodiments, each R is independently selected from alkyl groups having from 1 to 32, alternatively from 1 to 28, alternatively from 1 to 24, alternatively from 1 to 20, alternatively from 1 to 16, alternatively from 1 to 12, alternatively from 1 to 8, alternatively from 1 to 4, alternatively 1, carbon atoms, and from ethylenically unsaturated (i.e., alkenyl and/or alkynyl groups) groups having from 2 to 32, alternatively from 2 to 28, alternatively from 2 to 24, alternatively from 2 to 20, alternatively from 2 to 16, alternatively from 2 to 12, alternatively from 2 to 8, alternatively from 2 to 4, alternatively 2, carbon atoms. “Alkenyl” means an acyclic, branched or unbranched, monovalent hydrocarbon group having one or more carbon-carbon double bonds. Specific examples thereof include vinyl groups, allyl groups, hexenyl groups, and octenyl groups. “Alkynyl” means an acyclic, branched or unbranched, monovalent hydrocarbon group having one or more carbon-carbon triple bonds. Specific examples thereof include ethynyl, propynyl, and butynyl groups. Various examples of ethylenically unsaturated groups include CH₂═CH—, CH₂═CHCH₂—, CH₂═CH(CH₂)₄—, CH₂═CH(CH₂)₆—, CH₂═C(CH₃)CH₂—, H₂C═C(CH₃)—, H₂C═C(CH₃)—, H₂C═C(CH₃)CH₂—, H₂C═CHCH₂CH₂—, H₂C═CHCH₂CH₂CH₂—, HC═C—, HC═CCH₂—, HC═CCH(CH₃)—, HC═CC(CH₃)₂—, and HC═CC(CH₃)₂CH₂—. Typically, when R is an ethylenically unsaturated group, the ethylenic unsaturation is terminal in R. As understood in the art, ethylenic unsaturation may be referred to as aliphatic unsaturation.

In specific embodiments, only siloxy units indicated by subscript b include R groups having ethylenic unsaturation. In these embodiments, the R groups of siloxy units indicated by subscripts a and c are free of ethylenic unsaturation, and a specific example thereof is methyl. In certain embodiments, the (A) silicate resin includes, as siloxy units indicated by subscript b, both dimethylsiloxy units and methylvinyl siloxy units. In other embodiments, the (A) silicate resin includes, as siloxy units indicated by subscript b, methylvinyl siloxy units but not dimethyl siloxy units. The relative amount of such siloxy units can be selectively controlled when preparing the (A) silicate resin. As understood in the art, the siloxy units set forth above are exemplary only, and methyl may be replaced with other hydrocarbyl groups, and vinyl may be replaced with other ethylenically unsaturated groups.

In certain embodiments, the (A) silicate resin has a content of SiOZ moieties of from 12 to 80, alternatively from 15 to 70, alternatively from 15 to 60, alternatively from 15 to 50, alternatively from 15 to 40, alternatively from 15 to 30, mole percent based on the total number of moles of Si in each molecule. The content of SiOZ moieties can be calculated via ²⁹Si-NMR.

In particular, the molar content of the following siloxy units in the (A) silicate resin are determined:
W═R₃SiO_{1/2}
X1=R₂(OZ)SiO_{1/2}
X2=R₂SiO_{2/2}
Y1=R(OZ)₂SiO_{1/2}
Y2=R(OZ)SiO_{2/2}
Y3=RSiO_{3/2}
Z1=(OZ)₃SiO_{1/2}
Z2=(OZ)₂SiO_{1/2}
Z3=(OZ)SiO_{3/2}
Z4=SiO_{4/2}
   OZ content relative to silicon atoms as a mol % can be calculated with the following formula with the label for each peak in the formula corresponding to the integrated area under the peak corresponding to the label:

$$OZ content ( mol \% ) = 100 ⨯ ( \frac{( X 1 + 2 x Y 1 + Y 2 + 3 x Z 1 + 2 x Z 2 + Z 3 )}{( W + X 1 + X 2 + Y 1 + Y 2 + Y 3 + Z 1 + Z 2 + Z 3 + Z 4 )} )$$

In these or other embodiments, the (A) silicate resin has a weight percent of silicon-bonded ethylenically unsaturated groups of from greater than 0 to 10, alternatively from based on the total weight of the (A) silicate resin. The weight percent of silicon-bonded ethylenically unsaturated groups is independent from the viscosity of the (A) silicate resin, which is unlike the weight percent of silicon-bonded ethylenically unsaturated groups of conventional solid silicone resins, which is a function of the viscosity thereof once dispersed in a liquid organopolysiloxane polymer or vehicle. Thus, the weight percent of silicon-bonded ethylenically unsaturated groups can be increased without impacting viscosity of the (A) silicate resin, for example. The weight percent of silicon-bonded ethylenically unsaturated groups can be selective controlled when preparing the (A) silicate resin, as described below.

In these or other embodiments, the weight percent of silicon-bonded ethylenically unsaturated groups in the (A) silicate resin can be selectively controlled independent from viscosity of the (A) silicate resin. In contrast, in conventional silicone resins including silicon-boned ethylenically unsaturated groups, the content thereof is a function of viscosity, which limits the ability to selectively control content of silicon-bonded ethylenically unsaturated groups at certain viscosities, inherently limiting certain end use applications. In various embodiments, the (A) silicate resin has a weight-average molecular weight of from 1,000 to 100,000, alternatively from 1,000 to 50,000, alternatively from 1,000 to 10,000. Molecular weight may be measured via gel permeation chromatography (GPC) relative to polystyrene standards. In these or other embodiments, the (A) silicate resin has a viscosity at 25° C. of from 10 to 500,000, alternatively from 10 to 250,000, alternatively from 10 to 100,000, cP. Viscosity may be measured at 25° C. via a Brookfield LV DV-E viscometer with a spindle selected as appropriate to the viscosity of the (A) silicate resin, as understood in the art. The viscosity and the molecular weight of the (A) silicate resin can be controlled when preparing the (A) silicate resin. In other embodiments, the (A) silicate resin is a gum at 25° C., in which case the (A) silicate resin may not have a viscosity that can be readily measured at 25° C., but which still has flowable characteristics and is considered a liquid for purposes of this disclosure.

In various embodiments, the silicate resin is prepared from an MQ resin, where M designates (R⁰SiO_{3/2}) siloxy units, and Q designates (SiO_{4/2}) siloxy units, where R⁰ designates a silicon-bonded substituent. Such MQ resins are known in the art and are often in solid (e.g. powder or flake) form unless disposed in a solvent. However, typically in the nomenclature utilized in the art, M siloxy units are trimethylsiloxy units, whereas the MQ resin may include hydrocarbyl groups other than methyl groups. Typically, however, the M siloxy units of the MQ resin are trimethylsiloxy units.

The MQ resin may have formula MₙQ, where subscript n refers to the molar ratio of M siloxy units to Q siloxy units when the number of moles of Q siloxy units is normalized to 1. The greater the value of n, the lesser the crosslink density of the MQ resin. The inverse is also true, because as the value of n decreases, the number of M siloxy units decreases, and thus more Q siloxy units are networked without termination via an M siloxy unit. The fact that the formula for the MQ resin normalizes the content of Q siloxy units to 1 does not imply that the MQ resin includes only one Q unit. Typically, the MQ resin includes a plurality of Q siloxy units clustered or bonded together. The MQ resin may include, in certain embodiments, up to 4, alternatively up to 3, alternatively up to 2, weight percent of hydroxyl groups.

In specific embodiments, subscript n is <1, e.g. subscript n is from 0.05 to 0.99, alternatively from 0.10 to 0.95, alternatively from 0.15 to 0.90, alternatively from 0.25 to 0.85, alternatively from 0.40 to 0.80. In these embodiments, on a molar basis, there are more Q siloxy units than M siloxy units in the MQ resin. However, n may be >1 in other embodiments, e.g. from >1 to 6, alternatively from >1 to 5, alternatively from >1 to 4, alternatively from >1 to 3, alternatively from >1 to 2.

In specific embodiments, to prepare the (A) silicate resin from the MQ resin, the MQ resin is reacted with a silane compound in the presence of a base catalyst. The silane compound typically includes a silicon-bonded ethylenically unsaturated group and two silicon-bonded alkoxy groups. The silicon-bonded alkoxy groups can be independently selected and typically have from 1 to 10, alternatively from 1 to 8, alternatively from 1 to 6, alternatively from 1 to 4, alternatively 1 or 2, alternatively 1, carbon atom. For example, the silicon-bonded alkoxy groups can be methoxy, ethoxy, propoxy, butoxy, etc. For example, the silane compound can have formula R₂Si(OR)₂, where each R is independently selected, and at least one R that is not part of an alkoxy group is an ethylenically unsaturated group.

In the method of preparing the (A) silicate resin, the base catalyst typically cleaves siloxane bonds of the MQ resin, typically between M and Q siloxy units, to give SiOZ groups, where Z is defined above. The silane compound can hydrolyze and condense with the SiOZ groups to be incorporated therein. Both the cleaved siloxy bonds and inclusion of linear siloxy units attributable to the silane compound results in the (A) silicate resin being liquid at 25° C. in the absence of any solvent.

Because the silane compound is incorporated into the (A) silicate resin as D siloxy units, i.e., those indicated by [X] and subscript b, the silane compound may be selected based on desired D siloxy units. For example, with the (A) silicate resin includes methylvinyl siloxy units, the silane compound is a methylvinyldialkoxysilane, e.g. methylvinyldimethoxysilane. When the (A) silicate resin includes dimethylsiloxy units and methylvinylsiloxy units, the silane compound may comprise methylvinyldimethoxysilane in combination with dimethyldimethoxysilane. Thus, the silane compound may comprise two or more different silane compounds in concert.

In certain embodiments, where subscript c in the (A) silicate resin is greater than 0, the method further includes a second silane compound having three independently selected silicon-bonded alkoxy groups. The second silane compound is incorporated into the (A) silicate resin as siloxy units indicated by subscript c. The second silane compound may be functional, e.g. include a silicon-bonded ethylenically unsaturated group, or be non-functional, e.g. an alkyl group, in combination with the three independently selected silicon-bonded alkoxy groups.

The relative amount of the silane compound (and optionally second silane compound) utilized as compared to the MQ resin is a function of the desired subscript b (and optionally subscript c) in the (A) silicate resin. When more D siloxy units are desired, more of the silane compound is utilized, as vice versa. One of skill in the art understands how to selectively control such content in view of the description herein, including the Examples which follow this detailed description.

The MQ resin and the silane compound are reacted in the presence of a catalyst. Typically, the catalyst is an acid or a base such that the reaction between the MQ resin and the silane compound is either an acid catalyzed or a base catalyzed reaction. Typically, the reaction is base catalyzed. As such, in certain embodiments, the catalyst may be selected from the group of strong acid catalysts, strong base catalysts, and combinations thereof. The strong acid catalyst may be trifluoromethane sulfonic acid and the like. The catalyst is typically a strong base catalyst. Typically, the strong base catalyst is KOH, although other base catalysts, such as a phosphazene base catalyst, may be utilized.

The phosphazene catalyst, which generally includes at least one —(N═P<)— unit (i.e., a phosphazene unit) and is usually an oligomer having up to 10 such phosphazene units, for example having an average of from 1.5 up to 5 phosphazene units. The phosphazene catalyst may be, for example, a halophosphazene, such as a chlorophosphazene (phosphonitrile chloride), an oxygen-containing halophosphazene, an ionic derivative of a phosphazene such as a phosphazenium salt, particularly an ionic derivative of a phosphonitrile halide such as a perchlorooligophosphazenium salt, or a partially hydrolyzed form thereof.

In specific embodiments, the catalyst comprises a phosphazene base catalyst. The phosphazene base catalyst may be any known in the art but typically has the following chemical formula:

(R³₂N)₃P═N)ₜ(R³₂N)₃₋ₜP=NR³

wherein each R³ is independently selected from the group of a hydrogen atom, R, and combinations thereof, and t is an integer from 1 to 3. If R³ is a R, then R³ is typically an alkyl group having from 1 to 20, alternatively from 1 to 10, alternatively from 1 to 4, carbon atoms. The two R³ groups in the any (R³₂N) moiety may be bonded to the same nitrogen (N) atom and linked to complete a heterocyclic ring preferably having 5 or 6 members.

Alternatively, the phosphazene base catalyst may be a salt and have one of the following alternative chemical formulas:

[((R³₂N)₃P═N)ₜ(R³₂N)₃₋ₜP═N(H)R³]⁺[A⁻]; or

[((R³₂N)₃P═N)ₛ(R³₂N)₄₋ₛP]⁺[A⁻]

wherein each R³ is independently selected and defined above, subscript t is defined above, subscript s is an integer from 1 to 4, and [A] is an anion and is typically selected from the group of fluoride, hydroxide, silanolate, alkoxide, carbonate and bicarbonate. In one embodiment, the phosphazene base is an aminophosphazenium hydroxide.

In certain embodiments, the MQ resin and the silane compound are reacted at an elevated temperature, e.g. from 75 to 125° C., in the presence of a solvent. Suitable solvents may be hydrocarbons. Suitable hydrocarbons include aromatic hydrocarbons such as benzene, toluene, or xylene; and/or aliphatic hydrocarbons such as heptane, hexane, or octane. Alternatively, the solvent may be a halogenated hydrocarbon such as dichloromethane, 1,1,1-trichloroethane or methylene chloride. A neutralizing agent, such as acetic acid, may be utilized to neutralize the catalyst after the reaction. One of skill in the art can readily determine a catalytic quantity of the catalyst to be utilized, which is a function of its selection and reaction conditions. The resulting (A) silicate resin can be isolated or recovered from the reaction product via conventional techniques, e.g. stripping or other volatilization techniques.

The PSA composition further comprises (B) an organosilicon compound having an average of at least two silicon-bonded hydrogen atoms per molecule. The (B) organosilicon compound may be linear, branched, partly branched, cyclic, resinous (i.e., have a three-dimensional network), or may comprise a combination of different structures. The (B) organosilicon compound is typically a cross-linker and/or chain extender, and reacts with the ethylenically unsaturated groups of the (A) silicate resin. Typically, the (B) organosilicon compound comprises an organohydrogensiloxane.

The (B) organosilicon compound may comprise any combination of M, D, T, and/or Q siloxy units, so long as the (B) organosilicon compound includes at least two silicon-bonded hydrogen atoms per molecule. These siloxy units can be combined in various manners to form cyclic, linear, branched and/or resinous (three-dimensional networked) structures. The (B) organosilicon compound may be monomeric, polymeric, oligomeric, linear, branched, cyclic, and/or resinous depending on the selection of M, D, T, and/or Q units.

Because the (B) organosilicon compound includes an average of at least two silicon-bonded hydrogen atoms per molecule, with reference to the siloxy units set forth above, the (B) organosilicon compound may comprise any of the following siloxy units including silicon-bonded hydrogen atoms, optionally in combination with siloxy units which do not include any silicon-bonded hydrogen atoms: (R₂HSiO_{1/2}), (RH₂SiO_{1/2}), (H₃SiO_{1/2}), (RHSiO_{2/2}), (H₂SiO_{2/2}), and/or (HSiO_{3/2}), where R is independently selected and defined above.

In specific embodiments, the (B) organosilicon compound is a substantially linear, alternatively linear, polyorganohydrogensiloxane. The substantially linear or linear polyorganohydrogensiloxane has unit formula: (HR¹⁰₂SiO_{1/2})_{v′}(HR¹⁰SiO_{2/2})_{w′}(R¹⁰₂SiO_{2/2})_{x′}(R¹⁰₃SiO_{1/2})_{y′}, where each R¹⁰ is an independently selected monovalent hydrocarbon group, subscript v′ is 0, 1, or 2, subscript w′ is 0 or 1 or more, subscript x′ is 0 or more, subscript y′ is 0, 1, or 2, with the provisos that a quantity (v′+y′)=2, and a quantity (v′+w′) 2. The monovalent hydrocarbon group for R¹⁰ may be as described above for the monovalent hydrocarbon group for R. A quantity (v′+w′+x′+y′) may be 2 to 1,000. The polyorganohydrogensiloxane is exemplified by:
i) dimethylhydrogensiloxy-terminated poly(dimethyl/methylhydrogen)siloxane copolymer,
ii) dimethylhydrogensiloxy-terminated polymethylhydrogensiloxane,
iii) trimethylsiloxy-terminated poly(dimethyl/methylhydrogen)siloxane copolymer,
iv) trimethylsiloxy-terminated polymethylhydrogensiloxane, and/or
v) a combination of two or more of i), ii), iii), iv), and v). Suitable polyorganohydrogensiloxanes are commercially available from Dow Silicones Corporation of Midland, Mich., USA.

In one specific embodiment, the (B) organosilicon compound is linear and includes pendent silicon-bonded hydrogen atoms. In these embodiments, the (B) organosilicon compound may be a dimethyl, methyl-hydrogen polysiloxane having the average formula;

(CH₃)₃SiO[(CH₃)₂SiO]_{x′}[(CH₃)HSiO]_{w′}Si(CH₃)₃

where x′ and w′ are defined above. One of skill in the art understands that in the exemplary formula above the dimethylsiloxy units and methylhydrogensiloxy units may be present in randomized or block form, and that any methyl group may be replaced with any other hydrocarbon group free of aliphatic unsaturation.

In another specific embodiment, the (B) organosilicon compound is linear and includes terminal silicon-bonded hydrogen atoms. In these embodiments, the (B) organosilicon compound may be an SiH terminal dimethyl polysiloxane having the average formula:

H(CH₃)₂SiO[(CH₃)₂SiO]_{x′}Si(CH₃)₂H

where x′ is as defined above. The SiH terminal dimethyl polysiloxane may be utilized alone or in combination with the dimethyl, methyl-hydrogen polysiloxane disclosed immediately above. When a mixture is utilized, the relative amount of each organohydrogensiloxane in the mixture may vary. One of skill in the art understands that any methyl group in the exemplary formula above may be replaced with any other hydrocarbon group free of aliphatic unsaturation.

Alternatively still, the (B) organosilicon compound may include both pendent and terminal silicon-bonded hydrogen atoms.

In yet another specific embodiment, the (B) organosilicon compound has the formula H_{y′}R¹_{3-y′}Si—(OSiR¹₂)ₘ—(OSiR¹H)_{m′}—OSiR¹_{3-y′}H_{y′}, where each R¹ is an independently selected hydrocarbyl group free of ethylenic unsaturation, each y′ is independently selected from 0 or 1, subscripts m and m′ are each from 0 to 1,000 with the proviso that m and m′ are not simultaneously 0 and m+m′ is from 1 to 2,000, alternatively from 1 to 1,500, alternatively from 1 to 1,000.

In certain embodiments, the (B) organosilicon compound may comprise an alkylhydrogen cyclosiloxane or an alkylhydrogen dialkyl cyclosiloxane copolymer. Specific examples of suitable organohydrogensiloxanes of this type include (OSiMeH)₄, (OSiMeH)₃(OSiMeC₆H₁₃), (OSiMeH)₂(OSiMeC₆H₁₃)₂, and (OSiMeH)(OSiMeC₆H₁₃)₃, where Me represents methyl (—CH₃).

Other examples of suitable organohydrogensiloxanes for the (B) organosilicon compound are those having at least two SiH containing cyclosiloxane rings in one molecule. Such an organohydrogensiloxane may be any organopolysiloxane having at least two cyclosiloxane rings with at least one silicon-bonded hydrogen (SiH) atom on each siloxane ring. Cyclosiloxane rings contain at least three siloxy units (that is, the minimum needed in order to form a siloxane ring), and may be any combination of M, D, T, and/or Q siloxy units that forms a cyclic structure, provided that at least one of the cyclic siloxy units on each siloxane ring contains one SiH unit, which may be an M siloxy unit, a D siloxy unit, and/or a T siloxy unit. These siloxy units can be represented as MH, DH, and TH siloxy units respectively when other substituents are methyl.

The (B) organosilicon compound may comprise a combination or two or more different organohydrogensiloxanes that differ in at least one property such as structure, molecular weight, monovalent groups bonded to silicon atoms and content of silicon-bonded hydrogen atoms. The PSA composition may comprise the (B) organosilicon compound in an amount to give a molar ratio of silicon-bonded hydrogen atoms in component (B) to silicon-bonded ethylenically unsaturated groups in component (A) (and those of other components, if present), in an amount of from 0.01:1 to 5:1, alternatively from 0.1 to 3:1, alternatively from 0.3 to 2:1, alternatively from 0.3 to 1:1.

The PSA composition further comprises (C) a hydrosilylation-reaction catalyst. The (C) hydrosilylation-reaction catalyst is not limited and may be any known hydrosilylation-reaction catalyst for catalyzing hydrosilylation reactions. Combinations of different hydrosilylation-reaction catalysts may be utilized.

In certain embodiments, the (C) hydrosilylation-reaction catalyst comprises a Group VIII to Group XI transition metal. Group VIII to Group XI transition metals refer to the modern IUPAC nomenclature. Group VIII transition metals are iron (Fe), ruthenium (Ru), osmium (Os), and hassium (Hs); Group IX transition metals are cobalt (Co), rhodium (Rh), and iridium (Ir); Group X transition metals are nickel (Ni), palladium (Pd), and platinum (Pt); and Group XI transition metals are copper (Cu), silver (Ag), and gold (Au). Combinations thereof, complexes thereof (e.g. organometallic complexes), and other forms of such metals may be utilized as the (C) hydrosilylation-reaction catalyst.

Additional examples of catalysts suitable for the (C) hydrosilylation-reaction catalyst include rhenium (Re), molybdenum (Mo), Group IV transition metals (i.e., titanium (Ti), zirconium (Zr), and/or hafnium (Hf)), lanthanides, actinides, and Group I and II metal complexes (e.g. those comprising calcium (Ca), potassium (K), strontium (Sr), etc.). Combinations thereof, complexes thereof (e.g. organometallic complexes), and other forms of such metals may be utilized as the (C) hydrosilylation-reaction catalyst.

The (C) hydrosilylation-reaction catalyst may be in any suitable form. For example, the (C) hydrosilylation-reaction catalyst may be a solid, examples of which include platinum-based catalysts, palladium-based catalysts, and similar noble metal-based catalysts, and also nickel-based catalysts. Specific examples thereof include nickel, palladium, platinum, rhodium, cobalt, and similar elements, and also platinum-palladium, nickel-copper-chromium, nickel-copper-zinc, nickel-tungsten, nickel-molybdenum, and similar catalysts comprising combinations of a plurality of metals. Additional examples of solid catalysts include Cu—Cr, Cu—Zn, Cu—Si, Cu—Fe-AI, Cu—Zn—Ti, and similar copper-containing catalysts, and the like.

The (C) hydrosilylation-reaction catalyst may be in or on a solid carrier. Examples of carriers include activated carbons, silicas, silica aluminas, aluminas, zeolites and other inorganic powders/particles (e.g. sodium sulphate), and the like. The (C) hydrosilylation-reaction catalyst may also be disposed in a vehicle, e.g. a solvent which solubilizes the (C) hydrosilylation-reaction catalyst, alternatively a vehicle which merely carries, but does not solubilize, the (C) hydrosilylation-reaction catalyst. Such vehicles are known in the art.

In specific embodiments, the (C) hydrosilylation-reaction catalyst comprises platinum. In these embodiments, the (C) hydrosilylation-reaction catalyst is exemplified by, for example, platinum black, compounds such as chloroplatinic acid, chloroplatinic acid hexahydrate, a reaction product of chloroplatinic acid and a monohydric alcohol, platinum bis(ethylacetoacetate), platinum bis(acetylacetonate), platinum chloride, and complexes of such compounds with olefins or organopolysiloxanes, as well as platinum compounds microencapsulated in a matrix or core-shell type compounds. Microencapsulated hydrosilylation catalysts and methods of their preparation are also known in the art, as exemplified in U.S. Pat. Nos. 4,766,176 and 5,017,654, which are incorporated by reference herein in their entireties.

Complexes of platinum with organopolysiloxanes suitable for use as the (C) hydrosilylation-reaction catalyst include 1,3-diethenyl-1,1,3,3-tetramethyldisiloxane complexes with platinum. These complexes may be microencapsulated in a resin matrix. Alternatively, the (C) hydrosilylation-reaction catalyst may comprise 1,3-diethenyl-1,1,3,3-tetramethyldisiloxane complex with platinum. The (C) hydrosilylation-reaction catalyst may be prepared by a method comprising reacting chloroplatinic acid with an aliphatically unsaturated organosilicon compound such as divinyltetramethyldisiloxane, or alkene-platinum-silyl complexes. Alkene-platinum-silyl complexes may be prepared, for example by mixing 0.015 mole (COD)PtCl₂ with 0.045 mole COD and 0.0612 moles HMeSiCl₂.

The (C) hydrosilylation-reaction catalyst may also, or alternatively, be a photoactivatable hydrosilylation-reaction catalyst, which may initiate curing via irradiation and/or heat. The photoactivatable hydrosilylation-reaction catalyst can be any hydrosilylation-reaction catalyst capable of catalyzing the hydrosilylation reaction, particularly upon exposure to radiation having a wavelength of from 150 to 800 nanometers (nm).

Specific examples of photoactivatable hydrosilylation-reaction catalysts suitable for the (C) hydrosilylation-reaction catalyst include, but are not limited to, platinum(II) β-diketonate complexes such as platinum(II) bis(2,4-pentanedioate), platinum(II) bis(2,4-hexanedioate), platinum(II) bis(2,4-heptanedioate), platinum(II) bis(1-phenyl-1,3-butanedioate, platinum(II) bis(1,3-diphenyl-1,3-propanedioate), platinum(II) bis(1,1,1,5,5,5-hexafluoro-2,4-pentanedioate); (η-cyclopentadienyl)trialkylplatinum complexes, such as (Cp)trimethylplatinum, (Cp)ethyldimethylplatinum, (Cp)triethylplatinum, (chloro-Cp)trimethylplatinum, and (trimethylsilyl-Cp)trimethylplatinum, where Cp represents cyclopentadienyl; triazene oxide-transition metal complexes, such as Pt[C₆H₅NNNOCH₃]₄, Pt[p-CN—C₆H₄NNNOC₆H₁₁]₄, Pt[p-H₃COC₆H₄NNNOC₆H₁₁]₄, Pt[p-CH₃(CH₂)ₓ—C₆H₄NNNOCH₃]₄, 1,5-cyclooctadiene.Pt[p-CN—C₆H₄NNNOC₆H₁₁]₂, 1,5-cyclooctadiene.Pt[p-CH₃O—C₆H₄NNNOCH₃]₂, [(C₆H₅)₃P]₃Rh[p-CN—C₆H₄NNNOC₆H₁₁], and Pd[p-CH₃(CH₂)ₓ—C₆H₄NNNOCH₃]₂, where x is 1, 3, 5, 11, or 17; (η-diolefin)(σ-aryl)platinum complexes, such as (η⁴-1,5-cyclooctadienyl)diphenylplatinum, η⁴-1,3,5,7-cyclooctatetraenyl)diphenylplatinum, (η⁴-2,5-norboradienyl)diphenylplatinum, (η⁴-1,5-cyclooctadienyl)bis-(4-dimethylaminophenyl)platinum, (η⁴-1,5-cyclooctadienyl)bis-(4-acetylphenyl)platinum, and (η⁴-1,5-cyclooctadienyl)bis-(4-trifluormethylphenyl)platinum. Typically, the photoactivatable hydrosilylation-reaction catalyst is a Pt(II) p-diketonate complex and more typically the catalyst is platinum(II) bis(2,4-pentanedioate).

The (C) hydrosilylation-reaction catalyst is present in the PSA composition in a catalytic amount, i.e., an amount or quantity sufficient to promote curing thereof at desired conditions. The hydrosilylation-reaction catalyst can be a single hydrosilylation-reaction catalyst or a mixture comprising two or more different hydrosilylation-reaction catalysts.

The catalytic amount of the (C) hydrosilylation-reaction catalyst may be >0.01 ppm to 10,000 ppm; alternatively >1,000 ppm to 5,000 ppm. Alternatively, the typical catalytic amount of the (C) hydrosilylation-reaction catalyst is 0.1 ppm to 5,000 ppm, alternatively 1 ppm to 2,000 ppm, alternatively >0 to 1,000 ppm. Alternatively, the catalytic amount of (C) hydrosilylation-reaction catalyst may be 0.01 ppm to 1,000 ppm, alternatively 0.01 ppm to 100 ppm, alternatively 20 ppm to 200 ppm, and alternatively 0.01 ppm to 50 ppm of platinum group metal; based on the total weight of PSA composition.

In certain embodiments, the PSA composition further comprises (D) an organopolysiloxane having an average of at least two silicon-bonded ethylenically unsaturated groups per molecule. In certain embodiments, the (D) organopolysiloxane has an average, per molecule, of at least two silicon bonded groups having terminal aliphatic unsaturation. This (D) organopolysiloxane may be linear, branched, partly branched, cyclic, resinous (i.e., have a three-dimensional network), or may comprise a combination of different structures. The polyorganosiloxane may have average formula: R⁴ₐSiO_{(4-a)/2}, where each R⁴ is independently selected from a monovalent hydrocarbon group or a monovalent halogenated hydrocarbon group, with the proviso that in each molecule, at least two of R⁴ include aliphatic unsaturation, and where subscript a is selected such that 0<a≤3.2. Suitable monovalent hydrocarbon groups and monovalent halogenated hydrocarbon groups for R⁴ are as described above for R. The average formula above for the polyorganosiloxane may be alternatively written as (R⁴₃SiO_{1/2})_{b}(R⁴₂SiO_{2/2})_{c}(R⁴SiO_{3/2})_{d}(SiO_{4/2})ₑ, where R⁴ is defined above, and subscripts b, c, d, and e are each independently from ≥0 to ≤1, with the proviso that a quantity (b+c+d+e)=1. One of skill in the art understands how such M, D, T, and Q units and their molar fractions influence subscript a in the average formula above. T units (indicated by subscript d), Q units (indicated by subscript e) or both, are typically present in polyorganosiloxane resins, whereas D units, indicated by subscript c, are typically present in polyorganosiloxane polymers (and may also be present in polyorganosiloxane resins or branched polyorganosiloxanes).

Alternatively, the (D) organopolysiloxane may be substantially linear, alternatively is linear. The substantially linear organopolysiloxane may have the average formula: R⁴_{a′}SiO_{(4-a′)/2}, where each R⁴ and is as defined above, and where subscript a′ is selected such that 1.9≤a′≤2.2.

At 25° C., the substantially linear organopolysiloxane of component (D) may be a flowable liquid or may have the form of an uncured rubber. The substantially linear organopolysiloxane may have a viscosity of from 10 mPa·s to 30,000,000 mPa·s, alternatively from 10 mPa·s to 10,000 mPa·s, alternatively from 100 mPa·s to 1,000,000 mPa·s, and alternatively from 100 mPa·s to 100,000 mPa·s at 25° C. Viscosity may be measured at 25° C. via a Brookfield LV DV-E viscometer with a spindle selected as appropriate to the viscosity of the substantially linear polyorganosiloxane, i.e., RV-1 to RV-7. Typically, component (D) is a flowable liquid at 25° C. for miscibility with component (A).

Alternatively, when the (D) organopolysiloxane is substantially linear or linear, the (D) organopolysiloxane may have the average unit formula: (R⁶R⁵₂SiO_{1/2})ₐₐ(R⁶R⁵SiO_{2/2})_{bb}(R⁶₂SiO_{2/2})_{cc}(R⁵₃SiO_{1/2})_{dd}, where each R⁵ is an independently selected monovalent hydrocarbon group that is free of aliphatic unsaturation or a monovalent halogenated hydrocarbon group that is free of aliphatic unsaturation; each R⁶ is independently selected from the group consisting of alkenyl and alkynyl; subscript aa is 0, 1, or 2, subscript bb is 0 or more, subscript cc is 1 or more, subscript dd is 0, 1, or 2, with the provisos that a quantity (aa+dd) 2, and (aa+dd)=2, with the proviso that a quantity (aa+bb+cc+dd) is 3 to 2,000. Alternatively, subscript cc 0. Alternatively, subscript bb 2. Alternatively, the quantity (aa+dd) is 2 to 10, alternatively 2 to 8, and alternatively 2 to 6. Alternatively, subscript cc is 0 to 1,000, alternatively 1 to 500, and alternatively 1 to 200. Alternatively, subscript bb is 2 to 500, alternatively 2 to 200, and alternatively 2 to 100.

The monovalent hydrocarbon group for R⁵ is exemplified by an alkyl group of 1 to 6 carbon atoms, an aryl group of 6 to 10 carbon atoms, a halogenated alkyl group of 1 to 6 carbon atoms, a halogenated aryl group of 6 to 10 carbon atoms, an aralkyl group of 7 to 12 carbon atoms or a halogenated aralkyl group of 7 to 12 carbon atoms, where alkyl, aryl, and halogenated alkyl are as described herein. Alternatively, each R⁵ is an alkyl group. Alternatively, each R⁵ is independently methyl, ethyl, or propyl. Each instance of R⁵ may be the same or different. Alternatively, each R⁵ is a methyl group.

The aliphatically unsaturated monovalent hydrocarbon group for R⁶ is capable of undergoing hydrosilylation reaction. Suitable aliphatically unsaturated hydrocarbon groups for R⁶ are exemplified by an alkenyl group as defined herein and exemplified by vinyl, allyl, butenyl, and hexenyl; and alkynyl groups as defined herein and exemplified by ethynyl and propynyl. Alternatively, each R⁶ may be vinyl or hexenyl. Alternatively, each R⁶ is a vinyl group. The alkenyl or alkynyl content of the (D) organopolysiloxane may be 0.1% to 1%, alternatively 0.2% to 0.5%, based on the weight of the (D) organopolysiloxane.

When the (D) organopolysiloxane is substantially linear, alternatively is linear, the at least two aliphatically unsaturated groups may be bonded to silicon atoms in pendent positions, terminal positions, or in both pendent and terminal locations. As a specific example of the (D) organopolysiloxane having pendant silicon-bonded aliphatically unsaturated groups, starting material A) may have the average unit formula: [(CH₃)₃SiO_{1/2}]₂[(CH₃)₂SiO_{2/2}]_{cc}[(CH₃)ViSiO_{2/2}]_{bb}, where subscripts bb and cc are defined above, and Vi indicates a vinyl group. With regard to this average formula, any methyl group may be replaced with a different monovalent hydrocarbon group (such as alkyl or aryl), and any vinyl group may be replaced with a different aliphatically unsaturated monovalent hydrocarbon group (such as allyl or hexenyl). Alternatively, as a specific example of the polyorganosiloxane having an average, per molecule, of at least two silicon-bonded aliphatically unsaturated groups, the (D) organopolysiloxane may have the average formula: Vi(CH₃)₂SiO[(CH₃)₂SiO]_{cc}Si(CH₃)₂Vi, where subscript cc and Vi are defined above. The dimethyl polysiloxane terminated with silicon-bonded vinyl groups may be used alone or in combination with the dimethyl, methyl-vinyl polysiloxane disclosed immediately above as the (D) organopolysiloxane. With regard to this average formula, any methyl group may be replaced with a different monovalent hydrocarbon group, and any vinyl group may be replaced with any terminally aliphatically unsaturated monovalent hydrocarbon group. Because the at least two silicon-bonded aliphatically unsaturated groups may be both pendent and terminal, the (D) organopolysiloxane may alternatively have the average unit formula: [Vi(CH₃)₂SiO_{1/2}]₂[(CH₃)₂SiO_{2/2}]_{cc}[(CH₃)ViSiO_{2/2}]_{bb}, where subscripts bb and cc and Vi are defined above.

When the (D) organopolysiloxane is the substantially linear polyorganosiloxane, the (D) organopolysiloxane can be exemplified by a dimethylpolysiloxane capped at both molecular terminals with dimethylvinylsiloxy groups, a methylphenylpolysiloxane capped at both molecular terminals with dimethylvinylsiloxy groups, a copolymer of a methylphenylsiloxane and dimethylsiloxane capped at both molecular terminals with dimethylvinylsiloxy groups, a copolymer of a methylvinylsiloxane and a methylphenylsiloxane capped at both molecular terminals with dimethylvinylsiloxy groups, a copolymer of a methylvinylsiloxane and diphenylsiloxane capped at both molecular terminals with dimethylvinylsiloxy groups, a copolymer of a methylvinylsiloxane, methylphenylsiloxane, and dimethylsiloxane capped at both molecular terminals with dimethylvinylsiloxy groups, a copolymer of a methylvinylsiloxane and a methylphenylsiloxane capped at both molecular terminals with trimethylsiloxy groups, a copolymer of a methylvinylsiloxane and diphenylsiloxane capped at both molecular terminals with trimethylsiloxy groups, and a copolymer of a methylvinylsiloxane, methylphenylsiloxane, and a dimethylsiloxane capped at both molecular terminals with trimethylsiloxy groups.

Alternatively, the (D) organopolysiloxane may comprise a substantially linear, alternatively linear, polyorganosiloxane selected from the group consisting of:
i) dimethylvinylsiloxy-terminated polydimethylsiloxane,
ii) dimethylvinylsiloxy-terminated poly(dimethylsiloxane/methylvinylsiloxane),
iii) dimethylvinylsiloxy-terminated polymethylvinylsiloxane,
iv) trimethylsiloxy-terminated poly(dimethylsiloxane/methylvinylsiloxane),
v) trimethylsiloxy-terminated polymethylvinylsiloxane,
vi) dimethylvinylsiloxy-terminated poly(dimethylsiloxane/methylvinylsiloxane),
vii) dimethylvinylsiloxy-terminated poly(dimethylsiloxane/methylphenylsiloxane),
viii) dimethylvinylsiloxy-terminated poly(dimethylsiloxane/diphenylsiloxane),
ix) phenyl,methyl,vinyl-siloxy-terminated polydimethylsiloxane,
x) dimethylhexenylsiloxy-terminated polydimethylsiloxane,
xi) dimethylhexenylsiloxy-terminated poly(dimethylsiloxane/methylhexenylsiloxane),
xii) dimethylhexenylsiloxy-terminated polymethylhexenylsiloxane,
xiii) trimethylsiloxy-terminated poly(dimethylsiloxane/methylhexenylsiloxane),
xiv) trimethylsiloxy-terminated polymethylhexenylsiloxane
xv) dimethylhexenyl-siloxy terminated poly(dimethylsiloxane/methylhexenylsiloxane),
xvi) dimethylvinylsiloxy-terminated poly(dimethylsiloxane/methylhexenylsiloxane), and
xvii) a combination thereof.

Alternatively, the (D) organopolysiloxane may comprise a resinous polyorganosiloxane. The resinous polyorganosiloxane may have the average formula: R⁴_{a″}SiO_{(4-a″)/2}, where each R⁴ is independently selected as defined above, and where subscript a″ is selected such that 0.5≤a″≤1.7.

The resinous polyorganosiloxane has a branched or a three dimensional network molecular structure. At 25° C., the resinous polyorganosiloxane may be in a liquid or in a solid form. Alternatively, the resinous polyorganosiloxane may be exemplified by a polyorganosiloxane that comprises only T units, a polyorganosiloxane that comprises T units in combination with other siloxy units (e.g., M, D, and/or Q siloxy units), or a polyorganosiloxane comprising Q units in combination with other siloxy units (i.e., M, D, and/or T siloxy units). Typically, the resinous polyorganosiloxane comprises T and/or Q units. Specific example of the resinous polyorganosiloxane include a vinyl-terminated silsesquioxane (i.e., T resin) and a vinyl-terminated MDQ resin.

Alternatively, the (D) organopolysiloxane may comprise a branched siloxane, a silsesquioxane, or both a branched siloxane and a silsesquioxane.

When the (D) organopolysiloxane comprises a blend of different organopolysiloxanes, the blend may be a physical blend or mixture. For example, when the (D) organopolysiloxane comprises the branched siloxane and the silsesquioxane, the branched siloxane and the silsesquioxane are present in amounts relative to one another such that the amount of the branched siloxane and the amount of the silsesquioxane combined total 100 weight parts, based on combined weights of all components present in the PSA composition. The branched siloxane may be present in an amount of 50 to 100 parts by weight, and the silsesquioxane may be present in an amount of 0 to 50 parts by weight. Alternatively, the branched siloxane may be present in an amount 50 to 90 parts by weight and the silsesquioxane may be present in an amount of 10 to 50 parts by weight. Alternatively, the branched siloxane may be present in an amount of 50 to 80 parts by weight and the silsesquioxane may be present in an amount of 20 to 50 parts by weight. Alternatively, the branched siloxane may be present in an amount of 50 to 76 parts by weight and the silsesquioxane may be present in an amount of 24 to 50 parts by weight. Alternatively, the branched siloxane may be present in an amount of 50 to 70 parts by weight and the silsesquioxane may be present in an amount of 30 to 50 parts by weight.

The branched siloxane of the (D) organopolysiloxane may have unit formula: (R⁷₃SiO_{1/2})ₚ(R⁸R⁷₂SiO_{1/2})_{q}(R⁷₂SiO_{2/2})ᵣ(SiO_{4/2})ₛ, where each R⁷ is independently a monovalent hydrocarbon group free of aliphatic unsaturation or a monovalent halogenated hydrocarbon group free of aliphatic unsaturation and each R⁸ is an alkenyl group or an alkynyl group, both of which are as described above, subscript p≥0, subscript q>0, 15≥r≥995, and subscript s is >0.

In the unit formula immediately above, subscript p≥0. Subscript q>0. Alternatively, subscript q≥3. Subscript r is from 15 to 995. Subscript s is >0. Alternatively, subscript s≥1. Alternatively, for subscript p: 22≥p≥0; alternatively 20≥p≥0; alternatively 15≥p≥0; alternatively 10≥p≥0; and alternatively 5≥p≥0. Alternatively, for subscript q: 22≥q>0; alternatively 22≥q≥4; alternatively 20≥q>0; alternatively 15≥q>1; alternatively 10≥q≥2; and alternatively 15≥q≥4. Alternatively, for subscript r: 800≥r≥15; and alternatively 400≥r≥15. Alternatively, for subscript s: 10≥s>0; alternatively, 10≥s≥1; alternatively 5≥s>0; and alternatively s=1. Alternatively, subscript s is 1 or 2. Alternatively, when subscript s=1, subscript p may be 0 and subscript q may be 4.

The branched siloxane may contain at least two polydiorganosiloxane chains of formula (R⁷₂SiO_{2/2})ₘ, where each subscript m is independently 2 to 100. Alternatively, the branched siloxane may comprise at least one unit of formula (SiO_{4/2}) bonded to four polydiorganosiloxane chains of formula (R⁷₂SiO_{2/2})ₒ, where each subscript o is independently 1 to 100. Alternatively, the branched siloxane may have formula:

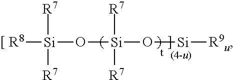

where subscript u is 0 or 1, each subscript t is independently 0 to 995, alternatively 15 to 995, and alternatively 0 to 100; each R⁹ is an independently selected monovalent hydrocarbon group, each R⁷ is an independently selected monovalent hydrocarbon group that is free of aliphatic unsaturation or a monovalent halogenated hydrocarbon group that is free of aliphatic unsaturation as described above, and each R⁸ is independently selected from the group consisting of alkenyl and alkynyl as described above. Suitable branched siloxanes are exemplified by those disclosed in U.S. Pat. No. 6,806,339 and U.S. Patent Publication 2007/0289495.

In specific embodiments, the branched siloxane has the formula (R²_{y}R¹_{3-y}SiO_{1/2})ₓ(R¹R²SiO_{2/2})_{z}(SiO_{4/2}), where each R¹ is an independently selected hydrocarbyl group free of ethylenic unsaturation; each R² is independently selected from R¹ and an ethylenically unsaturated group, subscript y is independently selected in each siloxy unit indicated by subscript x and is 1 or 2; each; subscript x is from 1.5 to 6; and subscript z is from 3 to 1,000. Specific examples of hydrocarbyl groups free of ethylenic unsaturation and ethylenically unsaturated groups are set forth above for R.

The silsesquioxane may have unit formula: (R⁷₃SiO_{1/2})ᵢ(R⁸R⁷₂SiO_{1/2})_{f}(R⁷₂SiO_{2/2})_{g}(R⁷SiO_{3/2})ₕ, where R⁷ and R⁸ are as described above, subscript i≥0, subscript f>0, subscript g is 15 to 995, and subscript h>0. Subscript i may be 0 to 10. Alternatively, for subscript i: 12≥i≥0; alternatively 10≥i≥0; alternatively 7≥i≥0; alternatively 5≥i≥0; and alternatively 3≥i≥0.

Alternatively, subscript f≥1. Alternatively, subscript f≥3. Alternatively, for subscript f: 12≥f>0; alternatively 12≥f≥3; alternatively 10≥f>0; alternatively 7≥f>1; alternatively 5≥f≥2; and alternatively 7≥f≥3. Alternatively, for subscript g: 800≥g≥15; and alternatively 400≥g≥15. Alternatively, subscript h≥1. Alternatively, subscript h is 1 to 10. Alternatively, for subscript h: 10≥h>0; alternatively 5≥h>0; and alternatively h=1. Alternatively, subscript h is 1 to 10, alternatively subscript h is 1 or 2. Alternatively, when subscript h=1, then subscript f may be 3 and subscript i may be 0. The values for subscript f may be sufficient to provide the silsesquioxane of unit formula (ii-II) with an alkenyl content of 0.1% to 1%, alternatively 0.2% to 0.6%, based on the weight of the silsesquioxane. Suitable silsesquioxanes are exemplified by those disclosed in U.S. Pat. No. 4,374,967.

The (D) organopolysiloxane may comprise a combination or two or more different polyorganosiloxanes that differ in at least one property such as structure, molecular weight, monovalent groups bonded to silicon atoms and content of aliphatically unsaturated groups. The PSA composition may comprise the (D) organopolysiloxane in an amount of from 60 to 99.5, alternatively from 60 to 98, alternatively from 60 to 95, alternatively from 70 to 95, alternatively from 75 to 95, weight percent based on the total weight of the PSA composition.

In certain embodiments, the PSA composition further comprises (E) an inhibitor. The (E) inhibitor may be used for altering the reaction rate or curing rate of the PSA composition, as compared to a composition containing the same starting materials but with the (E) inhibitor omitted. The (E) inhibitor is exemplified by acetylenic alcohols such as methyl butynol, ethynyl cyclohexanol, dimethyl hexynol, and 3,5-dimethyl-1-hexyn-3-ol, 1-butyn-3-ol, 1-propyn-3-ol, 2-methyl-3-butyn-2-ol, 3-methyl-1-butyn-3-ol, 3-methyl-1-pentyn-3-ol, 3-phenyl-1-butyn-3-ol, 4-ethyl-1-octyn-3-ol, and 1-ethynyl-1-cyclohexanol, and a combination thereof; cycloalkenylsiloxanes such as methylvinylcyclosiloxanes exemplified by 1,3,5,7-tetramethyl-1,3,5,7-tetravinylcyclotetrasiloxane, 1,3,5,7-tetramethyl-1,3,5,7-tetrahexenylcyclotetrasiloxane, and a combination thereof; ene-yne compounds such as 3-methyl-3-penten-1-yne, 3,5-dimethyl-3-hexen-1-yne; triazoles such as benzotriazole; phosphines; mercaptans; hydrazines; amines, such as tetramethyl ethylenediamine, dialkyl fumarates, dialkenyl fumarates, dialkoxyalkyl fumarates, maleates such as diallyl maleate; nitriles; ethers; carbon monoxide; alkenes such as cyclo-octadiene, divinyltetramethyldisiloxane; alcohols such as benzyl alcohol; and a combination thereof. Alternatively, the (E) inhibitor may be selected from the group consisting of acetylenic alcohols (e.g., 1-ethynyl-1-cyclohexanol) and maleates (e.g., diallyl maleate, bis maleate, or n-propyl maleate) and a combination of two or more thereof.

Alternatively, the (E) inhibitor may be a silylated acetylenic compound. Without wishing to be bound by theory, it is thought that adding a silylated acetylenic compound reduces yellowing of the reaction product prepared from hydrosilylation reaction of the PSA composition as compared to a reaction product from hydrosilylation of a composition that does not contain a silylated acetylenic compound or that contains an organic acetylenic alcohol inhibitor, such as those described above.

The silylated acetylenic compound is exemplified by (3-methyl-1-butyn-3-oxy)trimethylsilane, ((1,1-dimethyl-2-propynyl)oxy)trimethylsilane, bis(3-methyl-1-butyn-3-oxy)dimethylsilane, bis(3-methyl-1-butyn-3-oxy)silanemethylvinylsilane, bis((1,1-dimethyl-2-propynyl)oxy)dimethylsilane, methyl(tris(1,1-dimethyl-2-propynyloxy))silane, methyl(tris(3-methyl-1-butyn-3-oxy))silane, (3-methyl-1-butyn-3-oxy)dimethylphenylsilane, (3-methyl-1-butyn-3-oxy)dimethylhexenylsilane, (3-methyl-1-butyn-3-oxy)triethylsilane, bis(3-methyl-1-butyn-3-oxy)methyltrifluoropropylsilane, (3,5-dimethyl-1-hexyn-3-oxy)trimethylsilane, (3-phenyl-1-butyn-3-oxy)diphenylmethylsilane, (3-phenyl-1-butyn-3-oxy)dimethylphenylsilane, (3-phenyl-1-butyn-3-oxy)dimethylvinylsilane, (3-phenyl-1-butyn-3-oxy)dimethylhexenylsilane, (cyclohexyl-1-ethyn-1-oxy)dimethylhexenylsilane, (cyclohexyl-1-ethyn-1-oxy)dimethylvinylsilane, (cyclohexyl-1-ethyn-1-oxy)diphenylmethylsilane, (cyclohexyl-1-ethyn-1-oxy)trimethylsilane, and combinations thereof. Alternatively, the (E) inhibitor is exemplified by methyl(tris(1,1-dimethyl-2-propynyloxy))silane, ((1,1-dimethyl-2-propynyl)oxy)trimethylsilane, or a combination thereof. The silylated acetylenic compound useful as the (E) inhibitor may be prepared by methods known in the art, such as silylating an acetylenic alcohol described above by reacting it with a chlorosilane in the presence of an acid receptor.

The amount of the (E) inhibitor present in the PSA composition will depend on various factors including the desired pot life of the PSA composition, whether the PSA composition will be a one part composition or a multiple part composition, the particular inhibitor used, and the selection and amount of components (A)-(D). However, when present, the amount of the (E) inhibitor may be 0% to 1%, alternatively 0% to 5%, alternatively 0.001% to 1%, alternatively 0.01% to 0.5%, and alternatively 0.0025% to 0.025%, based on the total weight of the PSA composition. [0086] In certain embodiments, the PSA composition further comprises the (F) an adhesion promoter. Suitable adhesion promoters are exemplified by a reaction product of a vinyl alkoxysilane and an epoxy-functional alkoxysilane; a reaction product of a vinyl acetoxysilane and epoxy-functional alkoxysilane; and a combination (e.g., physical blend and/or a reaction product) of a polyorganosiloxane having at least one aliphatically unsaturated hydrocarbon group and at least one hydrolyzable group per molecule and an epoxy-functional alkoxysilane (e.g., a combination of a hydroxy-terminated, vinyl functional polydimethylsiloxane with glycidoxypropyltrimethoxysilane). Alternatively, the adhesion promoter may comprise a polyorganosilicate resin. Suitable adhesion promoters and methods for their preparation are disclosed, for example, in U.S. Pat. No. 9,562,149; U.S. Patent Application Publication Numbers 2003/0088042, 2004/0254274, and 2005/0038188; and European Patent 0 556 023.

Further examples of suitable adhesion promoters include a transition metal chelate, a hydrocarbonoxysilane such as an alkoxysilane, a combination of an alkoxysilane and a hydroxy-functional polyorganosiloxane, or a combination thereof. The (F) adhesion promoter may be a silane having at least one substituent having an adhesion-promoting group, such as an epoxy, acetoxy or acrylate group. The adhesion-promoting group may additionally or alternatively be any hydrolysable group which does not impact the (C) hydrosilylation-reaction catalyst. Alternatively, the (F) adhesion promoter may comprise a partial condensate of such a silane, e.g. an organopolysiloxane having an adhesion-promoting group. Alternatively still, the (F) adhesion promoter may comprise a combination of an alkoxysilane and a hydroxy-functional polyorganosiloxane.

Alternatively, the (F) adhesion promoter may comprise an unsaturated or epoxy-functional compound. The (F) adhesion promoter may comprise an unsaturated or epoxy-functional alkoxysilane. For example, the functional alkoxysilane can include at least one unsaturated organic group or an epoxy-functional organic group. Epoxy-functional organic groups are exemplified by 3-glycidoxypropyl and (epoxycyclohexyl)ethyl. Unsaturated organic groups are exemplified by 3-methacryloyloxypropyl, 3-acryloyloxypropyl, and unsaturated monovalent hydrocarbon groups such as vinyl, allyl, hexenyl, undecylenyl. One specific example of an unsaturated compound is vinyltriacetoxysilane.

Specific examples of suitable epoxy-functional alkoxysilanes include 3-glycidoxypropyltrimethoxysilane, 3-glycidoxypropyltriethoxysilane, (epoxycyclohexyl)ethyldimethoxysilane, (epoxycyclohexyl)ethyldiethoxysilane and combinations thereof. Examples of suitable unsaturated alkoxysilanes include vinyltrimethoxysilane, allyltrimethoxysilane, allyltriethoxysilane, hexenyltrimethoxysilane, undecylenyltrimethoxysilane, 3-methacryloyloxypropyl trimethoxysilane, 3-methacryloyloxypropyl triethoxysilane, 3-acryloyloxypropyl trimethoxysilane, 3-acryloyloxypropyl triethoxysilane, and combinations thereof.

The (F) adhesion promoter may also comprise the reaction product or partial reaction product of one or more of these compounds. For example, in a specific embodiment, the (F) adhesion promoter may comprise the reaction product or partial reaction product of vinyltriacetoxysilane and 3-glycidoxypropyltrimethoxysilane. Alternatively or in addition, the (F) adhesion promoter may comprise alkoxy or alkenyl functional siloxanes.

Alternatively, the (F) adhesion promoter may comprise an epoxy-functional siloxane such as a reaction product of a hydroxy-terminated polyorganosiloxane with an epoxy-functional alkoxysilane, as described above, or a physical blend of the hydroxy-terminated polyorganosiloxane with the epoxy-functional alkoxysilane. The (F) adhesion promoter may comprise a combination of an epoxy-functional alkoxysilane and an epoxy-functional siloxane. For example, the (F) adhesion promoter is exemplified by a mixture of 3-glycidoxypropyltrimethoxysilane and a reaction product of hydroxy-terminated methylvinylsiloxane with 3-glycidoxypropyltrimethoxysilane, or a mixture of 3-glycidoxypropyltrimethoxysilane and a hydroxy-terminated methylvinylsiloxane, or a mixture of 3-glycidoxypropyltrimethoxysilane and a hydroxy-terminated methylvinyl/dimethylsiloxane copolymer.

Alternatively, the (F) adhesion promoter may comprise a transition metal chelate. Suitable transition metal chelates include titanates, zirconates such as zirconium acetylacetonate, aluminum chelates such as aluminum acetylacetonate, and combinations thereof. Alternatively, the (F) adhesion promoter may comprise a combination of a transition metal chelate with an alkoxysilane, such as a combination of glycidoxypropyltrimethoxysilane with an aluminum chelate or a zirconium chelate.

The particular amount of the (F) adhesion promoter present in the PSA composition, if utilized, depends on various factors including the type of substrate and whether a primer is used. In certain embodiments, the (F) adhesion promoter is present in the PSA composition in an amount of from 0 to 2 parts by weight, per 100 parts by weight of component (A). Alternatively, the (F) adhesion promoter is present in the PSA composition in an amount of from 0.01 to 2 parts by weight, per 100 parts by weight of component (A).

In certain embodiments, the PSA composition further comprises (G) a vehicle. The (G) vehicle typically solubilizes the components of the PSA composition and, if the components solubilize, the (G) vehicle may be referred to as a solvent. Suitable vehicles include silicones, both linear and cyclic, organic oils, organic solvents and mixtures of these. The (G) vehicle is not required, but can optionally be utilized for application of the PSA composition onto a substrate.

Typically, the (G) vehicle, if present in the PSA composition, is an organic liquid. Organic liquids includes those considered oils or solvents. The organic liquids are exemplified by, but not limited to, aromatic hydrocarbons, aliphatic hydrocarbons, alcohols having more than 3 carbon atoms, aldehydes, ketones, amines, esters, ethers, glycols, glycol ethers, alkyl halides and aromatic halides. Hydrocarbons include isododecane, isohexadecane, Isopar L (C11-C13), Isopar H(C11-C12), hydrogenated polydecene, aromatic hydrocarbons, and halogenated hydrocarbons. Ethers and esters include isodecyl neopentanoate, neopentylglycol heptanoate, glycol distearate, dicaprylyl carbonate, diethylhexyl carbonate, propylene glycol n-butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, octyl ether, and octyl palmitate. Additional organic fluids suitable as a stand-alone compound or as an ingredient to the (G) vehicle include fats, oils, fatty acids, and fatty alcohols. The (G) vehicle may also be a low viscosity organopolysiloxane or a volatile methyl siloxane or a volatile ethyl siloxane or a volatile methyl ethyl siloxane having a viscosity at 25° C. in the range of 1 to 1,000 mm²/sec, such as hexamethylcyclotrisiloxane, octamethylcyclotetrasiloxane, decamethylcyclopentasiloxane, dodecamethylcyclohexasiloxane, octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, hexamethyl-3,3, bis{(trimethylsilyl)oxy}trisiloxane pentamethyl{(trimethylsilyl)oxy}cyclotrisiloxane as well as polydimethylsiloxanes, polyethylsiloxanes, polymethylethylsiloxanes, polymethylphenylsiloxanes, polydiphenylsiloxanes, caprylyl methicone, and any mixtures thereof.

In specific embodiments, the (G) vehicle is selected from polyalkylsiloxanes; tetrahydrofuran; mineral spirits; naphtha; an alcohol such as methanol, ethanol, isopropanol, butanol, or n-propanol; a ketone such as acetone, methylethyl ketone, or methyl isobutyl ketone; an aromatic hydrocarbon such as benzene, toluene, or xylene; an aliphatic hydrocarbon such as heptane, hexane, or octane; a glycol ether such as propylene glycol methyl ether, dipropylene glycol methyl ether, propylene glycol n-butyl ether, propylene glycol n-propyl ether, or ethylene glycol n-butyl ether; or a combination thereof.

The amount of the (G) vehicle will depend on various factors including the type of vehicle selected and the amount and type of other components present in the PSA composition. The (G) vehicle may be added during preparation of the PSA composition, for example, to aid mixing and delivery. All or a portion of the (G) vehicle may optionally be removed after the PSA composition is prepared, including prior to and/or contemporaneous with preparing the PSA from the PSA composition. Typically, however, the PSA composition is free from the (G) vehicle, and thus the PSA composition is a solventless PSA composition.

The PSA composition may optionally further comprise (H) a polyalkylsiloxane resin. The polyalkylsiloxane resin is an MQ resin consisting essentially of M and Q siloxy units. The M siloxy units may include ethylenic unsaturated groups bonded to silicon or non-functional organic groups, such as alkyl groups.

The (H) polyalkylsiloxanes resin may contain an average of 3 to 30 mole percent, alternatively 0.1 to 30 mole percent, alternatively 0.1 to 5 mole percent, alternatively 3 to 100 mole percent, of silicon-bonded alkenyl groups. The mole percent of silicon-bonded alkenyl groups in the (H) polyalkylsiloxanes resin is the ratio of the number of moles of alkenyl group-containing siloxy units in the (H) polyalkylsiloxanes resin to the total number of moles of siloxy units in the (H) polyalkylsiloxanes resin, multiplied by 100.

Methods of preparing such resins are well known in the art. For example, resin may be prepared by treating a resin copolymer produced by the silica hydrosol capping process of Daudt, et al. with at least an alkenyl-containing endblocking reagent. The method of Daudt et al., is disclosed in U.S. Pat. No. 2,676,182.

The (H) polyalkylsiloxanes resin, which typically contains less than 2% of silicon-bonded hydroxyl groups, may be prepared by reacting the product of Daudt, et al. with an alkenyl group-containing endblocking agent and an endblocking agent free of aliphatic unsaturation, in an amount sufficient to provide from 3 to 30 mole percent of unsaturated organic groups in the final product. Examples of endblocking agents include, but are not limited to, silazanes, siloxanes, and silanes. Suitable endblocking agents are known in the art and exemplified in U.S. Pat. Nos. 4,584,355; 4,591,622; and 4,585,836. A single endblocking agent or a mixture of such agents may be used to prepare the resin.

Other optional components may be present in the PSA composition, including, for example, reactive diluents, fragrances, preservatives, colorants, dyes, and fillers, for example, silica, quartz, carbon black, or chalk.

A method of preparing the PSA composition is also provided. The method comprises combining components (A)-(C), along with any optional components, to give the PSA composition. Typically, the (A) silicate resin is disposed in PSA composition directly in the absence of any solvent, such that both the PSA composition and its preparation method are free of solvent. However, the components may be combined in any manner, and in any order of addition, optionally with stirring or other mixing. Because the (A) silicate resin is miscible with or in the PSA composition, solvent is not required.

The PSA composition can be prepared by a method comprising combining the components by any convenient means such as mixing at ambient or elevated temperature. The (E) inhibitor may be added before the (C) hydrosilylation-react catalyst, for example, when the PSA composition will be prepared at elevated temperature and/or the PSA composition will be prepared as a one part composition.

Alternatively, the PSA composition may be prepared as a multiple part composition, for example, when the PSA will be stored for a long period of time before use. In the multiple part composition, the (C) hydrosilylation-reaction catalyst is typically stored in a separate part from any starting material having a silicon-bonded hydrogen atom, for example the (B) organosilicon compound, and the parts are combined shortly before use of the PSA composition. For example, a two part composition may be prepared by combining starting materials comprising (A) the silicate resin, (B) the organosilicon compound, and optionally one or more other additional starting materials described above to form a base part, by any convenient means such as mixing. A curing agent may be prepared by combining component (D), when utilized, and the (C) hydrosilylation-reaction catalyst, and optionally one or more other additional starting materials described above by any convenient means such as mixing. The starting materials may be combined at ambient or elevated temperature. The (E) inhibitor may be included in one or more of the base part, the curing agent part, or a separate additional part. The (F) adhesion promoter, when used, may be added to the base part, or may be added as a separate additional part. The (H) polyalkylsiloxane resin, when used, may be added to the base part, the curing agent part, or a separate additional part. When a two part composition is used, the weight ratio of amounts of base part to curing agent part may range from 1:1 to 10:1. The PSA composition will cure via a hydrosilylation reaction to form a pressure sensitive adhesive. In certain embodiments, the pressure sensitive adhesive formed by curing the PSA composition has at least some tackiness, which can be readily determined by touch or other known methods.

The method described above may further comprise one or more additional steps. The PSA composition prepared as described above may be used to form an adhesive article, e.g., a pressure sensitive adhesive (prepared by curing the PSA composition described above) on a substrate. The method described above may, therefore, further comprise comprises applying the PSA composition to a substrate.

Applying the PSA composition to the substrate can be performed by any convenient means. For example, the pressure sensitive adhesive curable composition may be applied onto a substrate by gravure coater, offset coater, offset-gravure coater, roller coater, reverse-roller coater, air-knife coater, or curtain coater.

The substrate can be any material that can withstand the curing conditions (described below) used to cure the pressure sensitive adhesive curable composition to form the pressure sensitive adhesive on the substrate. For example, any substrate that can withstand heat treatment at a temperature equal to or greater than 120° C., alternatively 150° C. is suitable.

Specific examples of suitable substrates include paper substrates such as Kraft paper, polyethylene coated Kraft paper (PEK coated paper), thermal paper, and regular papers; polymeric substrates such polyamides (PA); polyesters such as polyethylene terephthalates (PET), polybutylene terephthalates (PET), polytrimethylene terephthalates (PTT), polyethylene naphthalates (PEN), and liquid crystalline polyesters; polyolefins such as polyethylenes (PE), polypropylenes (PP), and polybutylenes; styrenic resins; polyoxymethylenes (POM); polycarbonates (PC); polymethylenemethacrylates (PMMA); polyvinyl chlorides (PVC); polyphenylene sulfides (PPS); polyphenylene ethers (PPE); polyimides (PI); polyamideimides (PAI); polyetherimides (PEI); polysulfones (PSU); polyethersulfones; polyketones (PK); polyetherketones; polyvinyl alcohols (PVA); polyetheretherketones (PEEK); polyetherketoneketones (PEKK); polyarylates (PAR); polyethernitriles (PEN); phenolic resins; phenoxy resins; celluloses such as triacetylcellulose, diacetylcellulose, and cellophane; fluorinated resins, such as polytetrafluoroethylenes; thermoplastic elastomers, such as polystyrene types, polyolefin types, polyurethane types, polyester types, polyamide types, polybutadiene types, polyisoprene types, and fluoro types; and copolymers, and combinations thereof. Alternatively, the substrate may be a metal foil such as aluminum foil or copper foil. The thickness of the substrate is not critical, however, the thickness may range from 5 micrometers to 300 micrometers.

To improve bonding of the pressure sensitive adhesive to the substrate, the method may optionally further comprise treating the substrate before applying the PSA composition. Treating the substrate may be performed by any convenient means, such as applying a primer, or subjecting the substrate to corona-discharge treatment, etching, or plasma treatment before applying the pressure sensitive adhesive composition to the substrate.

A coated article, e.g. an adhesive article such as a protective film, may be prepared by applying the PSA composition described above onto the substrate described above. The method may optionally further comprise removing the all, or a portion, of the solvent, if utilized, before and/or during curing. Removing solvent may be performed by any convenient means, such as heating at a temperature that vaporizes the solvent without fully curing the PSA composition, e.g., heating at a temperature of 70° C. to 120° C., alternatively 50° C. to 100° C., and alternatively 70° C. to 80° C. for a time sufficient to remove all or a portion of the solvent (e.g., 30 seconds to 1 hour, alternatively 1 minute to 5 minutes). The method then further comprises curing the PSA composition (which may have some or all of the solvent removed when the drying step is performed) room temperature or by heating at a temperature of 140° C. to 220° C., alternatively 150° C. to 220° C., alternatively 160° C. to 200° C., and alternatively 165° C. to 180° C. for a time sufficient to cure the PSA composition (e.g., for 30 seconds to an hour, alternatively 1 to 5 minutes). This forms a pressure sensitive adhesive on the substrate. Drying and/or curing may be performed by placing the substrate in an oven. The amount of the PSA composition to be applied to the substrate depends on the specific application, however, the amount may be sufficient such that after curing thickness of the pressure sensitive adhesive may be 5 micrometers to 200 micrometers, and for protective film the thickness may be 10 micrometers to 50 micrometers, alternatively 20 micrometers to 40 micrometers, and alternatively 30 micrometers.

The method described herein may optionally further comprise applying a removable release liner to the pressure sensitive adhesive opposite the substrate, e.g., to protect the pressure sensitive adhesive before use of the adhesive article.

The adhesive article (e.g., protective film) prepared as described above is suitable for use in flexible OLED device fabrication processes as a protective film with low adhesion, high adhesion stability, and/or low migration.

For example, a method for fabricating a flexible OLED device may include forming an OLED module on a surface of a substrate, e.g., a passivation layer on a surface of the OLED module opposite the substrate, and applying a protective film prepared as described herein to a surface of the passivation layer opposite the OLED module.

Separate from adhesive articles, the coated substrate may be utilized in diverse end use applications. For example, the coated substrate may be utilized in coating applications, packaging applications, adhesive applications, fiber applications, fabric or textile applications, construction applications, transportation applications, electronics applications, or electrical applications. However, the curable composition may be utilized in end use applications other than preparing the coated substrate, e.g. in the preparation of articles, such as silicone rubbers.

The following examples are intended to illustrate the invention and are not to be viewed in any way as limiting to the scope of the invention. Certain components utilized in the Examples are set forth in Table 1 below, followed by characterization and evaluation procedures also used in the Examples.

TABLE 1
Components

| Component | Chemical Description |
|---|---|
| Silicate Resin (A1) | W_{0.321}X^{Vi}_{0.184}Z_{0.495} |
| Silicate Resin (A2) | W_{0.323}X_{0.134}X^{Vi}_{0.031}Z_{0.513} |
| Silicate Resin (A3) | W_{0.313}X^{Vi}_{0.153}X^{Vi}_{0.018}Z_{0.516} |
| Silicate Resin (A4) | W_{0.289}X_{0.170}X^{Vi}_{0.031}Z_{0.511} |
| Silicate Resin (A5) | W_{0.256}X_{0.209}X^{Vi}_{0.030}Z_{0.504} |
| Silicate Resin (A6) | W_{0.256}X_{0.209}X^{Vi}_{0.030}Z_{0.504} |
| Silicate Resin (A7) | W_{0.265}X_{0.237}X^{Vi}_{0.007}Z_{0.492} |
| W | (CH₃)₃SiO_{1/2} |
| X^{Vi} | [MeViSiO_{1/2}(OZ)] and [MeViSiO_{2/2}] |
| X | [Me₂SiO_{1/2}(OZ)] and [Me₂SiO₂/₂] |
| Z | [SiO_{1/2}(OZ)₃], [SiO_{2/2}(OZ)₂], [SiO_{3/2}(OZ)], |
| | and [SiO_{4/2}] |
| OZ | OH or OMe |
| MQ Resin | [Me₃SiO_{1/2}]_{0.43}[SiO_{4/2}]_{0.57} |
| Silane Compound 1 | Vinylmethyldimethoxysilane |
| Silane Compound 2 | Dimethyldimethoxysilane |
| Catalyst | KOH |
| Neutralizing Agent | Acetic Acid |
| Organopolysiloxane | M^{Vi}D₉₂₀M^{Vi} |
| (D1) | |
| Organopolysiloxane | M^{Vi}D₅₇₃₁D^{Vi}₉₁M^{Vi} |
| (D2) | |
| MQ Resin Solution 1 | M_{0.37}M^{Vi}_{0.050}Q_{0.580} in Xylene, 70% solids |
| MQ Resin Solution 2 | M_{0.49}Q_{0.51} in Xylene, 70% solids |
| Inhibitor (E1) | Diallyl maleate |
| Solvent 1 | Toluene (C₇H₈) |
| Organosilicon | Me₃Si-terminated dimethyl methylhydrogen |
| | copolymer |
| Compound (B1) | (MD_{69.6}D^{Me,H}_{3.2}M) |
| Organosilicon | M^{H}D_{100.35}M^{H} |
| Compound (B2) | |
| Catalyst (C1) | Karstedt's catalyst in vinyl-functional siloxane. |

### Nuclear Magnetic Resonance Spectroscopy (NMR)

Nuclear magnetic resonance (NMR) spectra are obtained on a Varian EX-400 5 MHz Mercury spectrometer with CDCl₃ solvent. Chemical shifts for ¹H-NMR, ¹³C-NMR, and ²⁹Si-NMR spectra are referenced to internal solvent resonance and are reported relative to tetramethylsilane.

### Gel Permeation Chromatography (GPC)

Gel permeation chromatography (GPC) analysis is conducted on an Agilent 1260 Infinity II chromatograph equipped with a triple detector composed of a differential refractometer, an online differential viscometer, a low angle light scattering (LALS: 15° and 90° angles of detection), and a column (2 PL Gel Mixed C, Varian). Toluene (HPLC grade, Biosolve) is used as mobile phase, at a flow rate of 1 mL/min.

### Dynamic Viscosity (DV)

Dynamic viscosity (DV) is measured with a Brookfield DV-Ill Ultra Programmable Rheometer equipped with a CPA-52Z spindle, using a sample volume of 0.5 mL, at a temperature of 25° C.

### X-Ray Fluorescence (XRF)

X-Ray Fluorescence (XRF) is conducted on an Oxford Instruments Lab-X 3500 Benchtop XRF analyzer.

### SiOZ Content

The content of SiOZ moieties can be calculated via ²⁹Si-NMR. In particular, the molar content of the following siloxy units in each (A) silicate resin are determined:
W═R₃SiO_{1/2}
X1=R₂(OZ)SiO_{1/2}
X2=R₂SiO_{2/2}
Y1=R(OZ)₂SiO_{1/2}
Y2=R(OZ)SiO_{2/2}
Y3=RSiO_{3/2}
Z1=(OZ)₃SiO_{1/2}
Z2=(OZ)₂SiO_{1/2}
Z3=(OZ)SiO_{3/2}
Z4=SiO_{4/2}
   OZ content relative to silicon atoms as a mol % can be calculated with the following formula with the label for each peak in the formula corresponding to the integrated area under the peak corresponding to the label:

$$OZ content ( mol \% ) = 100 ⨯ ( \frac{( X 1 + 2 x Y 1 + Y 2 + 3 x Z 1 + 2 x Z 2 + Z 3 )}{( W + X 1 + X 2 + Y 1 + Y 2 + Y 3 + Z 1 + Z 2 + Z 3 + Z 4 )} )$$

R in the Examples can be methyl or vinyl.

### Adhesion:

Peel adhesion (180°) was tested in accordance with PSTC-101 standards. A TMI Release and Adhesion Tester was used to pull a 1-inch wide strip of adhesive coated onto 2-mil polyester film from a clean stainless steel or glass panel at 12 inches per minute.

### Tack

Tack was tested according to ASTM D2979. A PT-1000 Probe Tack Tester was used to obtain tack measurements from samples coated onto 2-mil polyester film. Dwell time was set to 1.0 second. Initial tackiness when evaluating various PSA compositions was determined by a finger touch.

### Static Shear (Room Temperature)

Static shear was tested according to ASTM D3654. A 1-inch by 1-inch sample was applied to a clean stainless steel panel. The sample was allowed to dwell at RT for 60 minutes prior to starting test. After 60 minutes, the panel was placed into the shear bank apparatus. A 500-gram weight was hung from each sample and the timer was reset to zero. Time was recorded until failure and test was stopped after 7 days if failure did not occur.

### Preparation Example 1: Silicate Resin (A1)

200 g of Solvent 1, followed by 300 g of MQ Resin were disposed in a 2 L flask equipped with a magnetic stir-bar. 109.0 grams of Silane Compound 1 and 0.30 grams of Catalyst were disposed in the flask. The contents of the flask were stirred at 100° C. under nitrogen, with progress of the reaction in the flask monitored via GC. After 10 hours, the contents of the flask were cooled to 23° C., and 0.5 grams of Neutralizing Agent were disposed in the flask to neutralize the Catalyst. The reaction product in the flask was filtered through a 1 micron filter to give a clear and viscous liquid. Silicate Resin (A1) was isolated from the reaction product through removal of volatiles via roto-vap. Silicate Resin (A1) was a colorless liquid having a DV of 39,000 cP at 25° C., a weight-average molecular weight of 2,969, and a polydispersity of 1.46, each as measured via GPC. The (A1) Silicate Resin had an SiOZ content of 23.5 mole % and a vinyl content of 6.46 wt. %.

### Preparation Example 2: Silicate Resin (A2)

200 g of Solvent 1, followed by 300 g of MQ Resin were disposed in a 2 L flask equipped with a magnetic stir-bar. 20.2 grams of Silane Compound 1, 80.6 grams of Silane Compound 2, and 0.30 grams of Catalyst were disposed in the flask. The contents of the flask were stirred at 100° C. under nitrogen, with progress of the reaction in the flask monitored via GC. After 10 hours, the contents of the flask were cooled to 23° C., and 0.5 grams of Neutralizing Agent were disposed in the flask to neutralize the Catalyst. The reaction product in the flask was filtered through a 1 micron filter to give a clear and viscous liquid. Silicate Resin (A2) was isolated from the reaction product through removal of volatiles via roto-vap. Silicate Resin (A2) was a colorless gum having liquid characteristics at 25° C., a weight-average molecular weight of 4,329, and a polydispersity of 1.55, each as measured via GPC. The (A2) Silicate Resin had an SiOZ content of 15.5 mole % and a vinyl content of 1.13 wt. %.

### Preparation Example 3: Silicate Resin (A3)

200 g of Solvent 1, followed by 300 g of MQ Resin were disposed in a 2 L flask equipped with a magnetic stir-bar. 10.4 grams of Silane Compound 1, 89.7 grams of Silane Compound 2, and 0.30 grams of Catalyst were disposed in the flask. The contents of the flask were stirred at 100° C. under nitrogen, with progress of the reaction in the flask monitored via GC. After 10 hours, the contents of the flask were cooled to 23° C., and 0.5 grams of Neutralizing Agent were disposed in the flask to neutralize the Catalyst. The reaction product in the flask was filtered through a 1 micron filter to give a clear and viscous liquid. Silicate Resin (A3) was isolated from the reaction product through removal of volatiles via roto-vap. Silicate Resin (A3) was a colorless gum having liquid characteristics at 25° C., a weight-average molecular weight of 5,397 and a polydispersity of 1.70, each as measured via GPC. The (A3) Silicate Resin had an SiOZ content of 14.35 mole % and a vinyl content of 0.68 wt. %.

### Preparation Example 4: Silicate Resin (A4)

200 g of Solvent 1, followed by 300 g of MQ Resin were disposed in a 2 L flask equipped with a magnetic stir-bar. 20.2 grams of Silane Compound 1, 131.1 grams of Silane Compound 2, and 0.30 grams of Catalyst were disposed in the flask. The contents of the flask were stirred at 100° C. under nitrogen, with progress of the reaction in the flask monitored via GC. After 10 hours, the contents of the flask were cooled to 23° C., and 0.5 grams of Neutralizing Agent were disposed in the flask to neutralize the Catalyst. The reaction product in the flask was filtered through a 1 micron filter to give a clear and viscous liquid. Silicate Resin (A4) was isolated from the reaction product through removal of volatiles via roto-vap. Silicate Resin (A4) was a colorless liquid having a DV of 75,000 cP at 25° C., a weight-average molecular weight of 5,450 and a polydispersity of 1.7149, each as measured via GPC. The (A4) Silicate Resin had an SiOZ content of 19.12 mole % and a vinyl content of 1.12 wt. %.

### Preparation Example 5: Silicate Resin (A5)

200 g of Solvent 1, followed by 300 g of MQ Resin were disposed in a 2 L flask equipped with a magnetic stir-bar. 20.2 grams of Silane Compound 1, 130.1 grams of Silane Compound 2, and 0.30 grams of Catalyst were disposed in the flask. The contents of the flask were stirred at 100° C. under nitrogen, with progress of the reaction in the flask monitored via GC. After 10 hours, the contents of the flask were cooled to 23° C., and 0.5 grams of Neutralizing Agent were disposed in the flask to neutralize the Catalyst. The reaction product in the flask was filtered through a 1 micron filter to give a clear and viscous liquid. Silicate Resin (A5) was isolated from the reaction product through removal of volatiles via roto-vap. Silicate Resin (A5) was a colorless liquid having a DV of 9,500 cP at 25° C., a weight-average molecular weight of 7,380 and a polydispersity of 1.90, each as measured via GPC. The (A5) Silicate Resin had an SiOZ content of 25.33 mole % and a vinyl content of 1.09 wt. %.

### Preparation Example 6: Silicate Resin (A6)

200 g of Solvent 1, followed by 300 g of MQ Resin were disposed in a 2 L flask equipped with a magnetic stir-bar. 10.4 grams of Silane Compound 1, 139.2 grams of Silane Compound 2, and 0.30 grams of Catalyst were disposed in the flask. The contents of the flask were stirred at 100° C. under nitrogen, with progress of the reaction in the flask monitored via GC. After 10 hours, the contents of the flask were cooled to 23° C., and 0.5 grams of Neutralizing Agent were disposed in the flask to neutralize the Catalyst. The reaction product in the flask was filtered through a 1 micron filter to give a clear and viscous liquid. Silicate Resin (A6) was isolated from the reaction product through removal of volatiles via roto-vap. Silicate Resin (A6) was a colorless liquid having a DV of 9,700 cP at 25° C., a weight-average molecular weight of 5,704 and a polydispersity of 1.73, each as measured via GPC. The (A6) Silicate Resin had an SiOZ content of 24.75 mole % and a vinyl content of 0.45 wt. %.

### Preparation Example 7: Silicate Resin (A7)

200 g of Solvent 1, followed by 300 g of MQ Resin were disposed in a 2 L flask equipped with a magnetic stir-bar. 3.8 grams of Silane Compound 1, 145.6 grams of Silane Compound 2, and 0.30 grams of Catalyst were disposed in the flask. The contents of the flask were stirred at 100° C. under nitrogen, with progress of the reaction in the flask monitored via GC. After 10 hours, the contents of the flask were cooled to 23° C., and 0.5 grams of Neutralizing Agent were disposed in the flask to neutralize the Catalyst. The reaction product in the flask was filtered through a 1 micron filter to give a clear and viscous liquid. Silicate Resin (A7) was isolated from the reaction product through removal of volatiles via roto-vap. Silicate Resin (A7) was a colorless liquid having a DV of 9,900 cP at 25° C., a weight-average molecular weight of 5,820 and a polydispersity of 1.76, each as measured via GPC. The (A7) Silicate Resin had an SiOZ content of 25.35 mole % and a vinyl content of 0.24 wt. %.

### Screening Examples 1-58

Screening Examples 1-58 are PSA compositions comprising the silicate resins prepared in Preparation Examples 1-7. The PSA compositions of Screening Examples 1-58 are prepared and cured to determine coating appearance by visual inspection and tackiness via finger touch evaluation. Each PSA of Screening Examples 1-58 are prepared by combining the particular (A) silicate resin with the particular (B) organosilicon compound in the absence of any solvent in a dental mixer cup to give a sample. The sample is mixed for 2 minutes at 2,000 rpm until homogeneous. The (E) inhibitor is added to cup and the sample is then hand mixed with a spatula. Then the (C) catalyst is added to the cup and hand mixed with a spatula. Finally, each sample is mixed once more on the dental mixer for 2 minutes at 2,000 rpm until homogeneous. The target platinum level was 50.0 ppm. The targeted Inhibitor/Platinum ratio was 20.0 (mol/mol). Each PSA composition of Screening Examples 1-58 was coated on to a 2-mil thick sheet of polyester (PET) using a 1.5-mil coating bar. Each sheet was then cured in an oven at 150° C. for 5 minutes. Tables 2-12 below set forth the relative amounts of each component in grams utilized to prepare the PSA compositions of Screening Examples 1-58. Screening Examples 1-58 various relative combinations of components, SiH-Vi molar ratios, for further evaluation of PSAs from the PSA compositions screened.

TABLE 2

| Component/Property | 1 | 2 | 3 | 4 | 5 |
|---|---|---|---|---|---|
| Silicate Resin (A1) | 2.63 | 2.34 | 2.10 | 1.81 | 2.11 |
| Organosilicon | 7.26 | 7.55 | 7.90 | 6.27 | 6.87 |
| Compound (B2) | | | | | |
| Organopolysiloxane (D1) | 0 | 0 | 0 | 1.81 | 0.91 |
| Inhibitor (E1) | 0.01 | 0.01 | 0.01 | 0.01 | 0.01 |
| Catalyst (C1) | 0.10 | 0.10 | 0.10 | 0.10 | 0.10 |
| SiH/Vi molar ratio | 0.30 | 0.35 | 0.40 | 0.35 | 0.35 |
| (mol/mol) | | | | | |
| Cure (Yes/No) | Yes | Yes | Yes | Yes | Yes |
| Coating Appearance | Good | Good | Good | Good | Good |
| (Good/Fair/Poor) | | | | | |
| Finger Tack | Tacky | Slight | Slight | Tacky | Slight |
| (None/Slight/Tacky) | | | | | |

TABLE 3

| Component/Property | 6 | 7 | 8 | 9 | 10 |
|---|---|---|---|---|---|
| Silicate Resin (A1) | 2.02 | 0.00 | 0.00 | 0.00 | 0.00 |
| Silicate Resin (A2) | 0.00 | 7.92 | 7.41 | 6.96 | 0.00 |
| Silicate Resin (A3) | 0.00 | 0.00 | 0.00 | 0.00 | 10.94 |
| Solvent 1 | 0 | 2.00 | 2.00 | 2.00 | 2.00 |
| Organosilicon | 7.01 | 11.87 | 12.38 | 12.83 | 8.85 |
| Compound (B2) | | | | | |
| Organopolysiloxane (D2) | 0.87 | 0.00 | 0.00 | 0.00 | 0.00 |
| Inhibitor (E1) | 0.01 | 0.02 | 0.02 | 0.02 | 0.02 |
| Catalyst (C1) | 0.10 | 0.19 | 0.19 | 0.19 | 0.19 |
| SiH/Vi molar ratio | 0.35 | 0.90 | 1.00 | 1.10 | 0.80 |
| (mol/mol) | | | | | |
| Cure (Yes/No) | Yes | Yes | Yes | Yes | No |
| Coating Appearance | Good | Good | Good | Good | n/a |
| (Good/Fair/Poor) | | | | | |
| Finger Tack | Tacky | Slight | Slight | Slight | n/a |
| (None/Slight/Tacky) | | | | | |

TABLE 4

| Component/Property | 11 | 12 | 13 | 14 | 15 |
|---|---|---|---|---|---|
| Silicate Resin (A3) | 9.80 | 8.88 | 0.00 | 0.00 | 0.00 |
| Silicate Resin (A4) | 0.00 | 0.00 | 8.54 | 7.96 | 7.45 |
| Solvent 1 | 2.00 | 2.00 | 0.00 | 0.00 | 0.00 |
| Organosilicon | 9.98 | 10.91 | 11.25 | 11.83 | 12.34 |
| Compound (B2) | | | | | |
| Inhibitor (E1) | 0.02 | 0.02 | 0.02 | 0.02 | 0.02 |
| Catalyst (C1) | 0.19 | 0.19 | 0.19 | 0.19 | 0.19 |
| SiH/Vi molar ratio | 1.00 | 1.20 | 0.80 | 0.90 | 1.00 |
| (mol/mol) | | | | | |
| Cure (Yes/No) | Yes | Yes | Yes | Yes | Yes |
| Coating Appearance | Good | Good | Good | Good | Good |
| (Good/Fair/Poor) | | | | | |
| Finger Tack | Tacky | Tacky | Tacky | Slight | Slight |
| (None/Slight/Tacky) | | | | | |

TABLE 5

| Component/Property | 16 | 17 | 18 | 19 | 20 |
|---|---|---|---|---|---|
| Silicate Resin (A6) | 0.00 | 0.00 | 0.00 | 10.42 | 9.69 |
| Silicate Resin (A7) | 12.86 | 12.22 | 11.63 | 0.00 | 0.00 |
| Organosilicon | 6.92 | 7.57 | 8.15522 | 9.36 | 10.10 |
| Compound (B2) | | | | | |
| Inhibitor (E1) | 0.02 | 0.02 | 0.02 | 0.02 | 0.02 |
| Catalyst (C1) | 0.19 | 0.19 | 0.19 | 0.19 | 0.19 |
| SiH/Vi molar ratio | 1.40 | 1.60 | 1.80 | 1.25 | 1.50 |
| (mol/mol) | | | | | |
| Cure (Yes/No) | Yes | Yes | Yes | Yes | Yes |
| Coating Appearance | Good | Good | Good | Good | Good |
| (Good/Fair/Poor) | | | | | |
| Finger Tack | Tacky | Slight | Slight | Slight | Tacky |
| (None/Slight/Tacky) | | | | | |

TABLE 6

| Component/Property | 21 | 22 | 23 | 24 | 25 |
|---|---|---|---|---|---|
| Silicate Resin (A6) | 8.89 | 15.98 | 15.01 | 14.14 | 13.36 |
| Organosilicon | 10.90 | 0.00 | 0.00 | 0.00 | 0.00 |
| Compound (B2) | | | | | |
| Organosilicon | 0.00 | 3.80 | 4.78 | 5.65 | 6.43 |
| Compound (B1) | | | | | |
| Inhibitor (E1) | 0.02 | 0.02 | 0.02 | 0.02 | 0.02 |
| Catalyst (C1) | 0.19 | 0.19 | 0.19 | 0.19 | 0.19 |
| SiH/Vi molar ratio | 1.75 | 0.75 | 1.00 | 1.25 | 1.50 |
| (mol/mol) | | | | | |
| Cure (Yes/No) | Yes | Yes | Yes | Yes | Yes |
| Coating Appearance | Good | Good | Good | Good | Good |
| (Good/Fair/Poor) | | | | | |
| Finger Tack | Tacky | Tacky | Tacky | Tacky | Slight |
| (None/Slight/Tacky) | | | | | |

TABLE 7

| Component/Property | 26 | 27 | 28 | 29 | 30 | 31 |
|---|---|---|---|---|---|---|
| Silicate Resin (A5) | 8.67 | 8.08 | 7.57 | 16.18 | 15.25 | 14.41 |
| Organosilicon Compound | 11.12 | 11.70 | 12.21 | 0.00 | 0.00 | 0.00 |
| (B2) | | | | | | |
| Organosilicon Compound | 0.00 | 0.00 | 0.00 | 3.61 | 4.54 | 5.37 |
| (B1) | | | | | | |
| Inhibitor (E1) | 0.02 | 0.02 | 0.02 | 0.02 | 0.02 | 0.02 |
| Catalyst (C1) | 0.19 | 0.19 | 0.19 | 0.19 | 0.19 | 0.19 |
| SiH/Vi molar ratio | 0.80 | 0.90 | 1.00 | 0.30 | 0.40 | 0.50 |
| (mol/mol) | | | | | | |
| Cure (Yes/No) | Yes | Yes | Yes | Yes | Yes | Yes |
| Coating Appearance | Good | Good | Good | Good | Good | Good |
| (Good/Fair/Poor) | | | | | | |
| Finger Tack | Tacky | Slight | Slight | Slight | Slight | Slight |
| (None/Slight/Tacky) | | | | | | |

TABLE 8

| Component/Property | 32 | 33 | 34 | 35 | 36 | 37 |
|---|---|---|---|---|---|---|
| MQ Resin Solution 2 | 3.28 | 7.48 | 12.70 | 3.28 | 7.48 | 12.70 |
| Silicate Resin (A5) | 0.00 | 0.00 | 0.00 | 0.00 | 0.00 | 0.00 |
| Silicate Resin (A6) | 9.69 | 9.69 | 9.69 | 9.69 | 9.69 | 9.69 |
| Organosilicon Compound | 2.49 | 4.02 | 9.36 | 0.00 | 0.00 | 0.00 |
| (B2) | | | | | | |
| Organosilicon Compound | 0.00 | 0.00 | 0.00 | 4.78 | 4.78 | 4.78 |
| (B1) | | | | | | |
| Inhibitor (E1) | 0.02 | 0.02 | 0.02 | 0.02 | 0.02 | 0.02 |
| Catalyst (C1) | 0.19 | 0.19 | 0.19 | 0.19 | 0.19 | 0.19 |
| SiH/Vi molar ratio | 1.50 | 1.50 | 1.50 | 1.00 | 1.00 | 1.00 |
| (mol/mol) | | | | | | |
| Cure (Yes/No) | Yes | Yes | Yes | Yes | Yes | Yes |
| Coating Appearance | Fair | Good | Fair | Fair | Good | Good |
| (Good/Fair/Poor) | | | | | | |
| Finger Tack | Tacky | Tacky | Tacky | Tacky | Slight | Slight |
| (None/Slight/Tacky) | | | | | | |

TABLE 9

| Component/Property | 38 | 39 | 40 | 41 | 42 |
|---|---|---|---|---|---|
| Silicate Resin (A1) | 9.07 | 5.32 | 3.00 | 1.76 | 0.95 |
| Organosilicon | 0.83 | 4.73 | 6.89 | 8.14 | 8.94 |
| Compound (B2) | | | | | |
| Inhibitor (E1) | 0.01 | 0.01 | 0.01 | 0.01 | 0.01 |
| Catalyst (C1) | 0.10 | 0.10 | 0.10 | 0.10 | 0.10 |
| SiH/Vi molar ratio | 0.05 | 0.10 | 0.25 | 0.50 | 1.00 |
| (mol/mol) | | | | | |
| Cure (Yes/No) | No | No | No | Yes | Yes |
| Coating Appearance | n/a | n/a | n/a | n/a | n/a |
| (Good/Fair/Poor) | | | | | |
| Finger Tack | n/a | n/a | n/a | None | None |
| (None/Slight/Tacky) | | | | | |

TABLE 10

| Component/Property | 43 | 44 | 45 | 46 | 47 |
|---|---|---|---|---|---|
| Silicate Resin (A1) | 0.65 | 0.48 | 1.99 | 2.20 | 0.00 |
| Silicate Resin (A2) | 0.00 | 0.00 | 0.00 | 0.00 | 4.41 |
| Solvent 1 | 0.00 | 0.00 | 0.00 | 0.00 | 1.00 |
| Organosilicon | 9.25 | 9.41 | 5.91 | 7.40 | 5.48 |
| Compound (B2) | | | | | |
| Organopolysiloxane | 0.00 | 0.00 | 1.99 | 0.00 | 0.00 |
| (D1) | | | | | |
| Organopolysiloxane | 0.00 | 0.00 | 0.00 | 0.24 | 0.00 |
| (D2) | | | | | |
| Inhibitor (E1) | 0.01 | 0.01 | 0.01 | 0.01 | 0.01 |
| Catalyst (C1) | 0.10 | 0.10 | 0.10 | 0.10 | 0.10 |
| SiH/Vi molar ratio | 1.50 | 2.00 | 0.30 | 0.35 | 0.75 |
| (mol/mol) | | | | | |
| Cure (Yes/No) | Yes | Yes | No | No | No |
| Coating Appearance | n/a | n/a | n/a | n/a | n/a |
| (Good/Fair/Poor) | | | | | |
| Finger Tack | None | None | n/a | n/a | n/a |
| (None/Slight/Tacky) | | | | | |

TABLE 11

| Component/Property | 48 | 49 | 50 | 51 | 52 |
|---|---|---|---|---|---|
| Silicate Resin (A2) | 3.19 | 0.00 | 0.00 | 0.00 | 0.00 |
| Silicate Resin (A3) | 0.00 | 5.63 | 3.88 | 0.00 | 0.00 |
| Silicate Resin (A4) | 0.00 | 0.00 | 0.00 | 3.20 | 2.49 |
| Solvent 1 | 1.00 | 1.00 | 1.00 | 0.00 | 0.00 |
| Organosilicon | 6.71 | 4.27 | 6.01 | 6.69 | 7.40 |
| Compound (B2) | | | | | |
| Inhibitor (E1) | 0.01 | 0.01 | 0.01 | 0.01 | 0.01 |
| Catalyst (C1) | 0.10 | 0.10 | 0.10 | 0.10 | 0.10 |
| SiH/Vi molar ratio | 1.25 | 0.75 | 1.50 | 1.25 | 1.75 |
| (mol/mol) | | | | | |
| Cure (Yes/No) | Yes | No | Yes | Yes | Yes |
| Coating Appearance | n/a | n/a | n/a | n/a | n/a |
| (Good/Fair/Poor) | | | | | |
| Finger Tack | None | n/a | None | None | None |
| (None/Slight/Tacky) | | | | | |

TABLE 12

| Component/Property | 53 | 54 | 55 | 56 | 57 | 58 |
|---|---|---|---|---|---|---|
| Silicate Resin (A5) | 0.00 | 0.00 | 0.00 | 3.26 | 2.54 | 5.65 |
| Silicate Resin (A6) | 7.40 | 5.87 | 4.09 | 0.00 | 0.00 | 0.00 |
| Organosilicon | 2.49 | 4.02 | 5.79 | 6.63 | 7.35 | 0.00 |
| Compound (B2) | | | | | | |
| Organosilicon | 0.00 | 0.00 | 0.00 | 0.00 | 0.00 | 4.24 |
| Compound (B1) | | | | | | |
| Inhibitor (E1) | 0.01 | 0.01 | 0.01 | 0.01 | 0.01 | 0.01 |
| Catalyst (C1) | 0.10 | 0.10 | 0.10 | 0.10 | 0.10 | 0.10 |
| SiH/Vi molar ratio | 0.50 | 1.00 | 2.00 | 1.25 | 1.75 | 1.00 |
| (mol/mol) | | | | | | |
| Cure (Yes/No) | Yes | Yes | Yes | Yes | Yes | Yes |
| Coating Appearance | n/a | n/a | n/a | n/a | n/a | n/a |
| (Good/Fair/Poor) | | | | | | |
| Finger Tack (None/ | None | None | None | None | None | None |
| Slight/Tacky) | | | | | | |

### Comparative Examples 1-4

Comparative Examples 1-4 (labeled as C1-C4) are comparative PSA compositions. Table 13 below sets forth the relative amounts of each component in grams utilized to prepare the comparative PSA compositions of Comparative Examples 1-4.

TABLE 13

| Component/Property | C1 | C2 | C3 | C4 |
|---|---|---|---|---|
| MQ Resin Solution 1 | 12.54 | 8.05 | 4.99 | 3.59 |
| Solvent 1 | 1.00 | 1.00 | 1.00 | 1.00 |
| Organosilicon | 7.25 | 11.74 | 14.79 | 16.20 |
| Compound (B1) | | | | |
| Inhibitor (E1) | 0.02 | 0.02 | 0.02 | 0.02 |
| Catalyst (C1) | 0.19 | 0.19 | 0.19 | 0.19 |
| SiH/Vi molar ratio | 0.20 | 0.50 | 1.00 | 1.50 |
| (mol/mol) | | | | |
| Cure (Yes/No) | Yes | Yes | Yes | Yes |
| Coating Appearance | Fair | Poor | Poor | Poor |
| (Good/Fair/Poor) | | | | |
| Finger Tack | Tacky | Slight | None | None |
| (None/Slight/Tacky) | | | | |

### Practical Examples 1-37 & Comparative Examples 1-4 and P1-P2: Coated Substrates

The PSAs of Examples 1-37 and Comparative Examples 1-4 are utilized to prepare coated substrates. The coated substrates comprise a PSA formed from the particular Screening Example disposed on a substrate. The coated substrates are prepared as described above in the Screening Examples. In the Practical Examples, Practical Example 1 is based on Screening Example 1; Practical Example 2 is based on Screening Example 2; and so on. The same is true for Comparative Examples 1-4. Screening Examples 38-58 were not further evaluated in connection with properties of the PSAs formed therefrom. Comparative Examples P1 and P2 are commercially available PSAs. Comparative Example P1 is a solventless PSA that is formed via solvent exchange with xylene. Comparative Example P2 is a solvent-based PSA. The physical properties of each PSA of Practical Examples 1-37 and Comparative Examples 1-4 and P1/P2 are set forth below in Tables 14-20, measured as described above.

TABLE 14

| Measurement | Units | 1 | 2 | 3 | 4 | 5 | 6 |
|---|---|---|---|---|---|---|---|
| 180° Peel | grams/inch | 6.64 | 4.41 | 2.43 | 3.74 | 4.28 | 7.39 |
| Adhesion from | | | | | | | |
| Stainless Steel | | | | | | | |
| 180° Peel | grams/inch | not | not | not | not | not | not |
| Adhesion from | | tested | tested | tested | tested | tested | tested |
| Glass | | | | | | | |
| Tack | grams | 82.8 | 31.8 | 52.1 | 55.6 | 48.0 | 66.0 |
| Static Shear | minutes | 10,080.0 | 10,080.0 | 10,080.0 | 10,080.0 | 10,080.0 | 10,080.0 |
| (Room | | | | | | | |
| Temperature) | | | | | | | |
| Static Shear | Cohesive/ | None | None | None | None | None | None |
| Failure Mode | Adhesive/ | | | | | | |
| | None | | | | | | |

TABLE 15

| Measurement | Units | 7 | 8 | 9 | 10 | 11 | 12 |
|---|---|---|---|---|---|---|---|
| 180° Peel | grams/inch | 11.46 | 3.24 | 3.50 | not | 14.70 | 6.02 |
| Adhesion from | | | | | tested | | |
| Stainless Steel | | | | | | | |
| 180° Peel | grams/inch | 13.67 | 6.90 | 4.48 | not | 15.20 | 7.91 |
| Adhesion from | | | | | tested | | |
| Glass | | | | | | | |
| Tack | grams | 200.8 | 93.8 | 72.3 | not | 208.0 | 101.8 |
| | | | | | tested | | |
| Static Shear | minutes | 171.3 | 10,080.0 | 10,080.0 | not | 1,272.8 | 10,080.0 |
| (Room | | | | | tested | | |
| Temperature) | | | | | | | |
| Static Shear | Cohesive/ | Adhesive | None | None | not | Adhesive | None |
| Failure Mode | Adhesive/ | | | | tested | | |
| | None | | | | | | |

TABLE 16

| Measurement | Units | 13 | 214 | 15 | 16 | 17 | 18 |
|---|---|---|---|---|---|---|---|
| 180° Peel | grams/inch | 9.80 | 6.44 | 4.23 | 8.51 | 7.90 | 7.29 |
| Adhesion from | | | | | | | |
| Stainless Steel | | | | | | | |
| 180° Peel | grams/inch | 11.30 | 7.15 | 6.77 | 13.60 | 8.05 | 13.07 |
| Adhesion from | | | | | | | |
| Glass | | | | | | | |
| Tack | grams | 163.4 | 92.8 | 60.5 | 211.4 | 123.1 | 114.3 |
| Static Shear | minutes | 258.5 | 10,080.0 | 10,080.0 | 280.4 | 1,120.8 | 2,056.3 |
| (Room | | | | | | | |
| Temperature) | | | | | | | |
| Static Shear | Cohesive/ | Adhesive | None | None | Adhesive | Adhesive | Adhesive |
| Failure Mode | Adhesive/ | | | | | | |
| | None | | | | | | |

TABLE 17

| Measurement | Units | 19 | 20 | 21 | 22 | 23 | 24 |
|---|---|---|---|---|---|---|---|
| 180° Peel | grams/inch | 31.60 | 7.61 | 4.45 | 925.00 | 168.00 | 68.40 |
| Adhesion from | | | | | | | |
| Stainless Steel | | | | | | | |
| 180° Peel | grams/inch | 30.30 | 10.70 | 7.86 | 959.00 | 146.00 | 60.90 |
| Adhesion from | | | | | | | |
| Glass | | | | | | | |
| Tack | grams | 201.5 | 148.4 | 90.1 | 202.1 | 284.0 | 187.5 |
| Static Shear | minutes | 10.1 | 409.3 | 10,080.0 | 10,080.0 | 10,080.0 | 10,080.0 |
| (Room | | | | | | | |
| Temperature) | | | | | | | |
| Static Shear | Cohesive/ | Cohesive | Adhesive | None | None | None | None |
| Failure Mode | Adhesive/ | | | | | | |
| | None | | | | | | |

TABLE 18

| Measurement | Units | 25 | 26 | 27 | 28 | 29 | 30 |
|---|---|---|---|---|---|---|---|
| 180° Peel | grams/inch | 15.70 | 14.70 | 4.91 | 3.01 | 361.00 | 83.90 |
| Adhesion from | | | | | | | |
| Stainless Steel | | | | | | | |
| 180° Peel | grams/inch | 12.50 | 12.28 | 6.86 | 6.34 | 312.00 | 56.40 |
| Adhesion from | | | | | | | |
| Glass | | | | | | | |
| Tack | grams | 124.3 | 189.6 | 79.5 | 62.3 | 3.2 | 85.2 |
| Static Shear | minutes | 10,080.0 | 15.6 | 2,953.6 | 10,080.0 | 10,080.0 | 10,080.0 |
| (Room | | | | | | | |
| Temperature) | | | | | | | |
| Static Shear | Cohesive/ | None | Cohesive | Adhesive | None | None | None |
| Failure Mode | Adhesive/ | | | | | | |
| | None | | | | | | |

TABLE 19

| Measurement | Units | 32 | 33 | 34 | 35 | 36 | 37 |
|---|---|---|---|---|---|---|---|
| 180° Peel | grams/inch | 34.30 | 117.00 | 471.00 | 912.00 | 121.00 | 14.20 |
| Adhesion from | | | | | | | |
| Stainless Steel | | | | | | | |
| 180° Peel | grams/inch | 30.90 | 109.00 | 411.00 | 816.00 | 122.00 | 18.70 |
| Adhesion from | | | | | | | |
| Glass | | | | | | | |
| Tack | grams | 196.8 | 365.5 | 645.3 | 116.5 | 3.8 | 0.1 |
| Static Shear | minutes | 37.4 | 694.0 | 10,080.0 | 10,080.0 | 10,080.0 | 10,080.0 |
| (Room | | | | | | | |
| Temperature) | | | | | | | |
| Static Shear | Cohesive/ | Adhesive | Adhesive | None | None | None | None |
| Failure Mode | Adhesive/ | | | | | | |
| | None | | | | | | |

TABLE 20

| Measurement | Units | P1 | P2 | C1 | C2 | C3 | C4 |
|---|---|---|---|---|---|---|---|
| 180° Peel | grams/inch | 1,388.00 | 200.00 | 538.00 | 4.85 | 0.13 | 0.65 |
| Adhesion from | | | | | | | |
| Stainless Steel | | | | | | | |
| 180° Peel | grams/inch | 1,459.00 | 181.00 | 309.00 | 3.38 | 0.47 | 0.07 |
| Adhesion from | | | | | | | |
| Glass | | | | | | | |
| Tack | grams | 354.0 | 291.6 | 724.6 | 52.1 | 1.8 | 0.9 |
| Static Shear | minutes | 10,080.0 | 10,080.0 | 95.3 | 10,080.0 | 10,080.0 | 10,080.0 |
| (Room | | | | | | | |
| Temperature) | | | | | | | |
| Static Shear | Cohesive/ | None | None | Cohesive | None | None | None |
| Failure Mode | Adhesive/ | | | | | | |
| | None | | | | | | |

### Definitions and Usage of Terms

Abbreviations used in the specification have the definitions in Table 21, below.

TABLE 21
Abbreviations

| Abbreviation | Definition |
|---|---|
| cP | centiPose |
| d | day |
| Da | Daltons |
| DP | degree of polymerization |
| FTIR | Fourier Transfer Infra-Red |
| g | grams |
| GC | gas chromatography |
| GPC | gel permeation chromatography |
| HPLC | high performance liquid chromatography |
| Me | methyl |
| mg | milligrams |
| MHz | megaHertz |
| mL | milliliters |
| mm | millimeters |
| Mn | number average molecular weight as measured by GPC |
| Mp | Peak molecular weight as measured by GPC |
| mPa · s | milli-Pascal seconds |
| MS | mass spectroscopy |
| Mw | weight average molecular weight |
| Mz | Z-average molecular weight |
| NMR | nuclear magnetic resonance |
| O.D. | outer diameter |
| PD | polydispersity |
| Ph | phenyl |
| ppm | parts per million |
| PTFE | polytetrafluoroethylene |
| RH | relative humidity |
| RT | room temperature of 25° C. |
| s | seconds |
| SiH content | hydrogen, as silicon bonded hydrogen, as measured |
| | by ²⁹Si NMR |
| THF | tetrahydrofuran |
| μL | microliter |
| μm | micrometer |
| Vi | vinyl |

It is to be understood that the appended claims are not limited to express and particular compounds, compositions, or methods described in the detailed description, which may vary between particular embodiments which fall within the scope of the appended claims.

1. A pressure sensitive adhesive (PSA) composition, comprising:
(A) a silicate resin that is a liquid at 25° C. in the absence of any solvent, the (A) silicate resin having an average of at least one silicon-bonded ethylenically unsaturated group per molecule;
(B) an organosilicon compound having at least two silicon-bonded hydrogen atoms per molecule; and
(C) a hydrosilylation-reaction catalyst;
wherein the (A) silicate resin is miscible in the PSA in the absence of any solvent;
wherein the (A) silicate resin has the average formula
[W]ₐ[X]_{b}[Y]_{c}[Z]_{d},
where 0.1≤a≤0.5; 0≤b<0.5; c is 0 or 0<c≤0.3; and 0.1≤d<0.9; with the proviso that a+b+c+d=1; and wherein:
[W] is [R₃SiO_{3/2}], where each R is an independently selected hydrocarbyl group;
[X] is [R₂SiO_{1/2}(OZ)]_{b′}[R₂SiO_{2/2}]_{b″}, where each R is independently selected and as defined above; 0≤b′≤b; 0≤b″≤b; with the proviso that b′+b″=b; and each Z is independently H, an alkyl group, or a cation;
[Y] is [RSi(OZ)_{c′}O_{(3-c′)/2}], where each R is independently selected and as defined above; each Z is independently selected and as defined above; c′ is an integer from 0 to 2 and is independently selected in each siloxy unit indicated by subscript c in the (A) silicate resin; and
[Z] is [Si(OZ)_{d′}O_{(4-d′)/2}], where each Z is independently selected and as defined above, and subscript d′ is an integer from 0 to 3 and is independently selected in each siloxy unit indicated by subscript d in the (A) silicate resin;
with the proviso that at least one R is an ethylenically unsaturated group.

2. The PSA composition of claim 1:
(i) formed substantially in the absence of any solvent;
(ii) substantially free from any solvent;
(iii) having at least some tackiness; or
(iv) any combination of (i) to (iii).

3. (canceled)

4. The PSA composition of claim 1, wherein subscript a is from 0.2 to 0.4; subscript b is from 0.1 to 0.3; subscript c is 0; and subscript d is from 0.4 to 0.6.

5. The PSA composition of claim 1, wherein subscript a is from 0.25 to 0.35; subscript b is from 0.15 to 0.25; subscript c is 0; and subscript d is from 0.45 to 0.55.

6. The PSA composition of claim 1, wherein the (B) organosilicon compound comprises an organohydrogensiloxane having the formula H_{y′}R¹_{3-y′}Si—(OSiR¹₂)ₘ—(OSiR¹H)_{m′}—OSiR¹_{3-y′}H_{y′}, where each R¹ is an independently selected hydrocarbyl group free of ethylenic unsaturation, each y′ is independently selected from 0 or 1, subscripts m and m′ are each from 0 to 1,000 with the proviso that m and m′ are not simultaneously 0 and m+m′ is from 1 to 1,000.

7. The PSA composition of claim 1, further comprising (D) an organopolysiloxane including at least two silicon-bonded ethylenically unsaturated groups.

8. The PSA composition of claim 1, wherein component (A):
(i) has a mole percent of SiOZ moieties of from 12 to 80 percent based on the total number of moles of Si in each molecule, wherein Z is independently selected from H, an alkyl group, or a cation;
(ii) has a weight percent of silicon-bonded ethylenically unsaturated groups of from greater than 0 to 10 based on the total weight of component (A); or
(iii) both (i) and (ii).

9. The PSA composition of claim 1, further comprising (E) a reaction inhibitor.

10. A method of preparing the PSA composition of claim 1, said method comprising:
combining components (A), (B) and (C) to give the PSA composition.

11. The method of claim 10, further comprising forming the (A) silicate resin from a solid silicate resin.

12. The method of claim 10, wherein the method is free from any solvents, and components (A), (B) and (C) are combined in the absence of any solvent.

13. A coated substrate, comprising:
a substrate; and
a coating formed from the PSA composition according to claim 1 disposed on the substrate.

14. The coated substrate of claim 13, wherein the coating is formed by curing the PSA composition.
